(19) United States
(12) Patent Application Publication
(10) Pub. No.: US 2014/0307439 A1
(43) Pub. Date: Oct. 16, 2014

(54) Power Station Has Built-In LED-Unit(s) and USB Charger(s) for Desk Top Installation

(71) Applicant: Tseng-Lu Chien, Walnut, CA (US)

(72) Inventor: Tseng-Lu Chien, Walnut, CA (US)

(21) Appl. No.: 13/863,073

(22) Filed: Apr. 15, 2013

(51) Int. Cl. F21V 33/00; H02J 7/00

(52) U.S. Cl. CPC F21V 33/0048; H02J 7/0042
USPC 362/253; 320/111

(57) ABSTRACT

The current invention offer a convenient multiple charger(s) has USB-charger(s) and Outlet(s) power source at hand-reachable distance and install on the surface(s) of the desk. The multiple charger(s) for USB are connect with input power source at 110-250 VAC range (variable depend on countries) to have output power at 3.5-8.5 VDC range (depend on requirement). Outlet(s) supply connect with input power source at 110-250 VAC (variable depend on countries) and still supply the same 110-250 VAC to other electric device(s) power. The current invention may incorporate with LED-unit(s), Surger protection, MOV circuit, bigger output current from USB-Charger output-end(s), wire-arrangement(s), rotating means to get more than one surface with different function(s), all these are appreciated the inventor's all co-pending application still be consider within the current invention's scope, range, claims, coverage.

The current invention are continuously filing of co-pending filing U.S. Ser. No. 12/950,017(#CCC) Multiple surface LED light filed on Nov. 29, 2010 with rotating device has LED light device(s) and USB device and Outlets device built-in on the rotating substrate with more than one surface to offer multiple function.

The said U.S. Ser. No. 12/950,017(# CCC) is continuously filing for U.S. Ser. No. 11/806,285 (Inventor's #R) filed on May 31, 2007 which also a multiple functions LED light device which are the continuously filing of the U.S. Pat. No. 7,318,652 (Iventor's #B) for multiple function Wall Cover which filed on Mar. 31, 2005. The current invention also continuously filing of U.S. Pat. No. 7,651,365 (Iventor's #F) filed on Jan. 15, 2005 which is CIP of Oct. 1, 2004. It also the CIP of U.S. Pat. No. 7,810,985 (Inventor's # A) file on Mar. 31, 2005 but it is CIP of Oct. 1, 2004 filing date too. All these patented or pending case all related to the Light source with Outlets device(s) which are part of the current invention features and got U.S. patents issues or co-pending. It is appreciated the all listed above patented or co-pending cases still treat as fall within the scope of current invention application and apply the priority terms for the current invention filing.

The current inventor also continuously filing for U.S. Ser. No. 13/161,643 filed on Jun. 16, 2011 for Desk-Top item with LED means has USB-unit(s) or USB-Module(s) to charge other electric or digital-data device.

The current invention also continuously filing for U.S. Ser. No. 13/117,227 filed on May 27, 2011 for Universal Module has USB-Unit(s) or/and Outlet-unit(s) for variety of electric or digital-data device.

### BACKGROUND

The current invention are different with the US prior art including:
1. U.S. Pat. No. 7,736,033→The Lamp Base with Electric device recharge receptacle & means→The Bhart's disclosure the Outlest device and the Cigar lighter build on the lamp base. The LampaBase make the input AC current transfer to output current to automobile current (12 Volt), then the Automobile Cigareet make the input current from (12 VDC) to USB end current (5 Volt). This means the Bhart's device at least need 2 expensive circuit/Transformer to get the USB Charger's output current from (120 VAC wall outlets) to (USB Current 5 VDC). This is not economical and none of people need 12 VoltDC for house use at all.
   The current invention direct install the USB Charger unit which transfer the input-end 120 VAC to output-end 5 VDC so this is practically.
2. US Prior art→Public 2011-017703 Rotabel & concealable device which only has the outlets device with manual switch. This is directly for 120 VAC outlets power source directly though metal piece and delivery 120 VAC to the rotabel & concealable device's receptacles to offer 120 VAC current while the other device's plug means connect with the said receptacle.
   '703 patent fail to disclosure the any USB charger concept, circuit, design and application so not have any related with the current invention for USB charger and the current invention device use Overlay to sit on existing lamp base to offer multiple power type power station with a lot of features.
3. US prior art: U.S. Pat. No. 7,897,277 Meyer et al, disclosure the Reversible battery cartridge which are use the AC batteries cartridge a the backup power for the all kind of lamp which mainly for power fail application.→This is nothing to do with USB ports and USB charger application. So there is totally different with current invention related to (1) USB ports+(2) USB Charging+(3) Outlet supply power source+(4) LED light and Universal lamp base to fit for all kind of existing lamp base so not occupy any new desk top space because (5) the Universal Desk base is overlay top of the existing lamp base.
   Further more, the current invention has (6) LED light incorporate with the above listed (1) (2) (3) (4) (5) so it become a unique practical Universal Power station because (7) the current invention is not only supply one kind of power to charger different electric or digital-data device(s).
4. US prior art—U.S. Pat. No. 6,474,823 Disclosure the laptop computer with top illumination light which is not for the AC power source into USB related circuit to transfer to the DC current to charge DC 5 Volt electric device. The Computer input-end current is 120 VAC but it pass though the computer its transformer already transfer to output-end current at 5 VDC and then there is no any USB Charger circuit inside the computer so the computer's external transformer which directly to delivery 5 VDC current to the to the USB Port so the computer system which is not same as current inventions the input-end current is 120 VAC though USB Charger inside circuit to get the output-end for 5 VDC.
   The total circuit and concept is different because computer prior art use the EXTERNAL Transformer which not belong to computer itself parts to transfer the 120V Outlet power→Though EXTERNAL transformer get 5 VDC current (Outside the computer)→The Computer itself input-end current is 5 VDC and output-end current of USB ports also is 5 VDC so it proof, Computer itself is no any USB Charger circuit inside.

Hereafter, The current invention has following features as below:
A. Offer the most convenient to use USB or Outlets or LED unit(s) on desk surface:

The current invention for all the power station or the products can install on the desk top very steady and overcome the super heavy duty of the power cord which from the wall outlet to the said power station or the said product(s) for pulling strength made by the cords weight.

The normal design for all market extension cord with built-in outlets or has more features including USB ports, Audio-ports, video-ports, internet-ports, other electric's ports which all can not put on the desk top because the power-cord weight are way too heavy if the said outlets extension cords meet the safety authorities requirement if may need power cords from gauge 10, 12, 14, 16 so the cord are very heavy duty x the different length from 1 feets to 100 feets so it is impossible to install on the desk top.

Further more, the outlets device no one really need to put on desk top because it too few times to plug into or dis-plug the plugs of electric or electronic devices. Maybe only one time so no one really need the existing simple outlets extension cord to put on desk top.

However, the current the current invention has built-in USB ports or LED light device which will need to connect the USB-ports or turn on-off the said LED unit(s) many times per day or once for each other day because the cellphone/mobile phone/smart phone/ipad/panel communication or consumer/computer device(s) need to be charged from USB ports so the current invention to offer the most convenient to put the USB-ports and LED units on the desk top to prevent from people bend the body and knee down to connect the grounded multiple function extension cord or wall mounted USB ports, The current invention offer the most convenient for people to get power from built-in from outlets, USB ports, and make functions of built-in LED units just on desk top.

This is the major concept for the current invention.
B. The Simple installation to install power station or products on desk surface;
C. The power station has its own features as (3) co-pending filing for all unique features to supply power to charge the majority of electric, digital-data, audio, video, internet device(s) on desk top no need to bend body for ground or near ground areas for frequently to connect power source from outlet(s), USB port(s), LED unit(s).

The co-pending filing cases earlier background as below:

This application is continuously filing for U.S. Ser. No. 13/117,227 which filed on May 30, 2011 for Universal module has built-in USB-unit or Outlet-units for electric or digital data device(s).

This application also is Continuously filing for U.S. Ser. No. 12/502,661, U.S. Ser. No. 12/292,580, U.S. Ser. No. 12/566,322, U.S. Ser. No. 11/498,874, U.S. Ser. No. 11/527,629, U.S. Ser. No. 12/622,000, U.S. Ser. No. 12/624,621 which disclosured the sealed-unit with uniform dimension of shape to fit into the same uniform dimension of compartment to put the universal sealed-unit fit into variety of LED light device. The features for all parent filings has following features:
a. Sealed-unit(s) has uniform dimension to fit into the uniform compartment of said any kind of LED light device.
b. Sealed-unit(s) has passed all related safety standard with laboratory's issued safety certification so can fit into the any other LED light device's parts and accessories which may or may not have pass the said Safety standard which the said sealed-unit(s) passed in variety safety requirements.
c. Sealed-unit(s) can be any individual salable unit because it is passed the all related safety requirements and standard. The other parts or accessories may or may not just for decorative or other functions' parts and accessories to make the said LED light device become more valuable for perfect appearance.

(1) The current invention keep the same concept to disclosure the sealed-unit has passed all the relative safety standard so can add on the other electric device(s) which not limited for LED light device. It will be cover for LED light device, Power strip device, wall outlet device, Surge protection device, wall adaptor device, charging device(s), smart phone related device(s), computer related device(s), consumer electric device(s).

(2) The current invention disclosure to use sealed-unit which at this time in the form of the USB-Unit, Outlet-unit not same as earlier discussed LED-Unit, or outlet-unit, or battery-pack, or prong-means for all co-pending filing patents.

(3) The current invention disclosure to said USB-unit or outlet-unit both are offer the said power from these units to offer the electric power though these USB-unit or Outlet-units to said variety of electric device so can keep the said variety electric device(s) can be in good power condition for people to use.

(4) The current invention disclosure the said USB-Unit or Outlet-Unit both and its own related circuit-means, conductive-means, contact-means, receiving-means, output-ends, input-ends, electric parts and accessories so can get the electric power from the prong-cable means or USB-Cable means to the receiving-means and let variety of electric device(s) get the said power.

(5) The current invention has universal design for the said USB-units or Outlet-unit with the most compact size to make the each of the USB-unit or Outlet-unit or any combination of the said USB-units and Outlet-units to form the desired module to fit into the said all kind of electric device(s) including LED light device, wall outlets, wall outlet adaptor, power strips, surge protectors, communication device, computer device, consumer electric device, smart phone device, panel computer device etc.

(6) The current invention of the said USB-Units or Outlet-units has passed all related safety standard and has its own issued certification so the Finished Electric Device do not need to get other safety certification related to the said USB-units or Outlet-units.

(7) The current invention of the said the module which can be selected from group combination from the USB-units, Outlet-units, conductive wire, conductive plate, conductive means, contact-means, prong-cable means, USB-cable means, prong-means, resilient conductive means, printed circuit means, flexible circuit means, related electric parts and accessories, fix means, position means, installation means to make the said module or outlet-unit or USB-unit to pass the safety standard and get the related safety certification to add on the said other electric device.

(8) The said module has different specification such as

1 USB-unit with 1 USB-ports,
1 USB-unit with 2 USB-ports+1 Outlet-unit,
1 USB-unit with 2 USB-ports+2 outlets-unit,
1 outlet-unit.
or
any combination for the USB-units and Outlet-units for standard module to fit for different electric device(s) needed.

(9) The said module has different specification including:

USB port has different current output including 500 ma, 1 Amp, 1.1 Amp, 2.2 Amp to make the said 2 USB-Ports can charge the different electric device such as iphone need to have 1 Amp, ipad need 2.1 Amp.

If people want to charge the 1 iphone+1 ipad at the same time, it will be need at least 3.1 Amp module. This will be very expensive.

If people want to charge the 1 iphone or 1 pad at the different time, so the standard module can be 1 prot 1 Amp+1 port 1.1 Amp=2.1 Amp total, the cost will be cheaper.

If People want to charge only 1 iphone, That only need 1 USB-unit with 1 port which has only 1 Amp for economical products.

Hence, the Standard module will be not only limited one specification as above discussion.

(10) The features for use Standard Module or Outlet-unit or USB-unit as a sealed-unit to has its own issued safety certification so can fit into the Uniform compartment of any other electric device which will save people to file each different electric devices' UL or ETL or CSA safety certification and save a lot of time for tooling development, Safety testament for each different electric device. This will reduce a lot of R&D, development, tooling, file for safety standard time and fee.

From Co-Pending filing for “Universal module of USB-unit or Outlet-unit for electric or digital data device” U.S. Ser. No. 13/117,227, the current invention make a more simple arrangement to make the said “Desk Top items with LED means has USB-unit(s) or USB-Module (s) to charge variety of electric or digital data device(s)” not only by a universal module because some of the desk top items with LED means has plenty of room/space so can load the bigger size of the USB-unit(s) or USB-Module(s) so can get down of cost for the related electric components or parts or accessories so it can has more cost attractive to consumer.

The said USB-unit(s) means an electric charging unit which has USB-female receiving means to receive the USB-male prong to build the electric power delivery from the USB-female receiving means to the other device's USB-male prong. The preferred USB-female receiving means get power from power source and its circuit means to make the desire electric power for current style, voltage,

and certain amount of current flow in Amperage (A or ma) so can charge the USB-male means to get power into other electric or digital device(s).

The said USB-module(s) means an electric charging module which has at least one USB-female receiving means but also has numbers of the receiving means in group combination select from outlet-female receiving means, USB-female receiving means, adaptor's female receiving means, or any conventional female receiving means to form a one body which has more than one USB-female receiving means to offer same or different electric power though the different female receiving means within the said one body. The said USB-module connect with power source and circuit-means to offer the desire electric power under predetermined current type, voltage, current amperage (A or ma) to charge the other device(s) while the female receiving means connect with the male prong means of each style of the connect-means.

Here of the said Desk Top items which means the objects which allow people to easily to reach or touch or operate or management the said items and the said USB-unit(s) or USB-module(s) are install on or within the said item or the substrate(s). The items position on the said location where people will stay for period of time such as desk, table, bed, chair, land, grass wherever the place people to work, rest, take nap.

For example people use the computer or laptop computer or iphone or ipad or icloud on the some substrate(s) or location or place such as table, desk, bed, laptop stand, laptop supporter, laptop cushion or any similar surface(s) which allow people to work or sleep or lay down for period of time so can charge the other electric or digital data device(s).

All such place people will stay for period of time and the nearby desk top items with LED means has the USB-units build-in on the said items so can easily to offer the electric power to all the other electric or digital data device(s), so it is very easily for people who do not need to bend the body to find the power source under table where normally has far away distance than distance to the desk top items has LED means. Hence, this offer a good convenience for people while they work, rest, or even take a nap, they can easily to use the USB-unit(s) or USB-Module from the Desk Top items with LED means to charge their small phone, computer, i-pad or any other electric or digital data device(s) while they work, rest, sleep or take a nap.

The Co-Pending filing for Universal Module of the said USB-unit(s) or Outlet-unit(s) which is the 1st purpose of the Universal module which try to get the best cute dimension to make it as small as possible in size so can fit into as many as applications' limited housing so can become the really meet the universal purpose.

However, the smallest or slimmest or most compact size of the said USB-Unit(s) or Outlet-unit(s) or USB-module will be too expensive such as APPLE iphone's or ipad's USB-unit which is very small size so its need use very compact transformer or inverter with super big power output so it will be very expensive but has very short time can fully charge the other electric or digital data device(s). However, in order to get USB-3.0 standard has 2.1 amp output from the USB-unit(s), it also can get such output current by using bigger size for the some electric components or parts & accessories such as transformer or inverter or other same functions electric parts & accessories to get same big power output but the cost will big drop to let consumer save pocket money for some Desk Top items which may including from group combination of Desk Lamp, Desk Top Clock, Desk Top Radio, Desk top Fan, Desk Top lighting, Reading light, Wall Reading light, Head lighting, Book light, Electric picture display, Night light with AC to DC power source or adaptor with prong & wire means, Project light with AC to DC power source or adaptors with prong & wire means, Electric Candle set with AC to DC power source or adaptors with prong & wire means, or any LED device which for Desk Top as earlier definition for desk top items. The said all such example which the items which has no any USB-unit or USB-ports designed only for charging purpose and can not has delivery digital data.

Hence, the said desk top items which has the function(s), performance, effects(s) including the light beams, project image, time image, clock, illumination, music, power source, electric signals, photos, digital signals including sound, light, music, smell or any conventional market available devices which people will put near by the body and stay for period of time so can charge other electric or digital data device(s).

### BRIEF DESCRIPTION OF THE DRAWINGS

FIG. 1 is an isometric view showing rotation of a rotatable LED light according to a 1^{st} preferred embodiment for Multiple surface(s) LED light which has 1^{st} surface has LED element(s) recess installed on. While the external force applied to the LED light and make it rotate to turn the 2^{nd} surface fix on position by lock means to offer people the outlets for power source and Internet socket and phone socket to let people has convenient function on same location of the said LED light.

The single location of the surface can have multiple electric application will save a lot of space especially for working table or under cabinet light fixtures. The FIG. 1 has all brief illustration for quickly understanding.

FIGS. 2A and 2B, and FIGS. 3A and 3B show one application of the 1^{st} preferred embodiment while the said multiple surface(s) LED light been apply to ceiling, walls, door, surface by itself without any other main objects or substrates or housing means. The said itself means the multiple surface LED light are directly install for building, house, Big furniture, such as ceiling, wall, door, closet, cabinet not like the power strips, LED light fixture, Light device, light bars.

The all parts and accessories to make such multiple surfaces LED light as drawing.

FIG. 4, FIG. 5, FIG. 6A, FIG. 6B, FIG. 7, FIG. 8, FIG. 9, FIG. 10, FIG. 10A, FIG. 10B, FIG. 10C, and FIG. 11 show applications of the 1^{st} preferred embodiment while the said multiple surface(s) LED light been apply to the other main objects or other substrate or other hosing means which the said main objects or substrate or housing means is a individual existing products available at market place which maybe a power strips, light fixture, extension cord (co-inventor's U.S. Pat. No. 7,824,185), wall outlet device, LED light device (as co-inventor's U.S. Pat. No. 7,618,150), foldable device, extendable device (as co-inventor's (U.S. Pat. No. 7,722,230), removable device (as co-inventor's U.S. Pat. No. 7,726,839), Transforming device (as co-inventor's U.S. Pat. No. 7,726,841). All these existing products while change the construction or design, then, It will become a very useful and practically items because it will be multiple function(s) than original products which should be make more valuable for peoples.

FIG. 12 includes perspective views of a prior art universal module having outlet-unit(s) or usb-unit(s) for a variety of electric or digital data device, to which the principles of the present invention may be applied.

FIGS. 13 and 14 show a preferred 2^{nd} embodiment which has build in Universal module has outlet-unit(s) or USB-unit(s) for the 2^{nd} embodiment which has the build in LED light, Outlet-unit(s), USB-unit(s), Holder means, Support means, prong means or cable means with plug to make the said wall-outlets or wall-adaptors or extension-cord (while incorporate with cable means with plug) can offer USB-charger or 120 Volt 60 HZ or other electric power to people for very practical products.

FIGS. 15A-15C a preferred 3^{rd} embodiment which has the different high and low outlet-unit(s) or/and USB-unit(s) on one power strips which can also put the other electric device(s) on the lower outlet-unit(s) or USB-unit(s) to become some special design multiple functions power strips. It can be powered by battery as in FIG. 15B or use cable with prong-plug as extension cord or power strip. The each of the Outlet-unit(s) or USB-unit(s) can be rotatable if market required as co-inventor's issued or co-pending filing cases. To apply the Universal Module of current invention will be most simple to change from Original outlets or LED-sealed units to multiple functions devices.

FIGS. 16A-16C show outlet-units with rotatable orientation features according to another preferred embodiment. It can be direct plug-in wall to get power or use cable-prong-plug as existing extension cord/power strips to get power away from the wall or outlets device(s). The current invention just arrange some outlet-unit(s) to become the USB-Unit(s) so can have extra functions, features. To apply the Universal Module of current invention will be most simple to change from Original outlets or LED-sealed units to multiple functions devices.

FIGS. 17A-17D, 18A, 18B, 19A, 19B, and 20A-20C show different power sources for a variety consumer electric device(s) which can add the USB-unit or Outlet-unit as required too. Especially the FIG. 13 show the extension cord or power strip which has plurality of the outlets and USB-Unit. The most important the this preferred embodiment contain the “Mater control function” which means while the outside electric device(s) plug into the master control outlet and turn on/off the said electric device(s), The master outlets will be activated and turn on/off all the other outlet(s) or USB-unit(s) so can save people to turn on/off each other outlet's related electric device(s). It also will turn off all the other outlets or USB-Unit power while the said Master control outlets been disconnect with the said other electric device.” This is the other features can add top of the said current Universal Module has outlet-units or/and usb-units.

FIGS. 21-49 show further preferred embodiments of desk top items with LED means has USB-unit(s) to charge other electric or digital data device(s).

FIG. 21 shows 2 USB-units and 1 outlet-unit on front view. The said 1^{st} preferred embodiment is a 12 LEDs USB powered light and powered from the USB plug-wire means.

FIG. 22 shows a preferred embodiment side view of the desk top items with LED means to charge other electric or digital data device(s) which has the 1 USB-unit and 2 outlet-units on the side of the base. The said 1^{st} preferred embodiment is a 12 LEDs USB powered light and powered from the USB plug-wire means.

FIG. 23 shows a preferred embodiment for 1^{st} desired design which has 3 USB-unit(s) with different power output to charge the different electric or digital data device(s). The USB-unit(s) may has 500 ma, 1,000 ma, 2,100 ma to charge different electric or digital data device(s) such as iphone and ipad for different requirement for charging current.

FIG. 24 shows a preferred embodiment for 2^{nd} desired design which has 2 USB-units and 1 outlet-unit so can allow people to charge or supply power source to the ipad, iphone and power the laptop computer or other device which can get power from the said USB-unit(s) or Outlet-Unit. From drawing it also show the difference and comparison between the embodiment #1 and #2 with details difference. All such Alternative, improvement, equivalent function, replaceable, similar functions still fall within the current invention and co-inventor's prior art as discuss on this filing case also fall within the current invention scope.

FIG. 25 shows a preferred embodiment of the desk top item which is a LED lighting fixture with adjustable arms to make the LEDs lamp for desired height, orientation, direction, angle so can get best illumination to people. The build-in 1 USB-unit and 1 outlet-unit which has lower cost than other above discuss with plurality of USB-units and Outlet-units. The desk top item powered by the transformer from wall outlets for 120 Volt AC current which is different from the Preferred embodiment #1 which powered by the USB plug & Wire. The 2^{nd} preferred embodiment powered by UL listed adaptor. The current powered by 120 Volt Wall Power though the transformer.

FIG. 26 shows a preferred embodiment which are powered by Solar power and storage the solar electricity inside the rechargeable batteries so can have enough power to charge other electric or digital data device(s) though the build-in USB-unit (s) and Outlet-unit(s) incorporated with proper circuit means so can meet Market requirement.

FIG. 27 shows a preferred embodiment which use Solar power, It is appreciated that the said items can be powered by any market available power source including group combination selected from solar power, wind power, chemical power, batteries power, generator, transformer, adaptors, inverter, inductor etc.

FIG. 28 shows a preferred embodiment which has thicker or higher base which can have bigger space to arrange the bigger size electric parts & accessories so can save a lot of cost for super compact, slim, cute size of the electric parts & accessories. Further more, the thicker or higher base which also can load the rotating USB-unit(s) or USB-Module so can keep the 1st surface of USB-Module look nice while not use the said USB-unit(s) or USB-Module which location on the 2^{nd} surface of the USB-Module. This embodiment details description also show on the drawing FIG. 8 for plurality of USB-units and other numbers of the said receiving means on the said 2^{nd} or more surface of the said USB-Module. This details rotating USB module details can seen from the FIG. 18, FIG. 19, FIG. 20, FIG. 21, FIG. 22 can see all very details descriptions, illustration which also can check from co-inventor's co-pending filing case Ser. No. 13/117,227 for all details too. It is appreciated all co-inventor's co-pending filing case's all illustrations, drawing, figure, background, details description and its alternative, same function, equivalent skill, improvement, upgrade still fall within the current invention.

FIGS. 29-32 show preferred embodiments which has thicker or higher base of the said Desk Top Items with LED means, so can add the rotating USB-modules which has plurality of USB-Unit(s) and plurality of other receiving means to increase more function(s), feature(s), effects, performance(s). The said USB-Module has at least more than 1 surface so can change the desired surface for certain purpose. The said more than 1 surface of the said USB-Module means the surface number from 2 to N (any number).

FIG. 33 show a preferred embodiment in which the Desk Top item which has super big base size so can install plurality of the said rotating USB-Module(s) so can offer a group of people to charge their electric or digital device(s) at the same time such as the train station, bus station, airport, meeting room, hotel lobby . . . etc. Such Desk top item has super big and higher base with plurality USB-modules may call Charging harbor.

FIG. 34 shows a preferred embodiment in which the desk top items with LED means has USB-unit(s) or USB-module or Outlet-unit(s) to allow people charge the other electric or digital device(s) which the said items including radio, time piece, weather station display, fruit blender, food machine, liquid machine, LED lighting, light fixture, projector means, electric fan, heater or any conventional items with LED means build-in and has USB-unit(s) or USB-module(s) build in to allow people charge other electric or digital data device(s) while the stay a period of time near-by the said desk top items.

FIGS. 35-37 show preferred embodiments in which the different LEDs means used for LED lighting for above discussed preferred embodiments or other LED Desk lamp or LED lamp for desk top. From all these drawing has details for each LEDs means and its arrangement and details discussion so can save examiner a lot of time to understand the difference and comparison.

FIGS. 38-42 show details of the said USB-Module with at least one of the USB-unit(s) and plurality of receiving means which may has group combination from USB-unit(s), Outlet-unit(s), Internet-unit(s),

Adaptor-unit(s), other light means, or other light source with its parts ̂& accessories, or any conventional available receiving means all fall within the current invention for the said USB-Module which has at least more than 2 surface(s) and each surface has its special designs.

FIGS. 43-49 show all kind of the desk top items which offer the function(s), effects(s), performance(s) to people's eye, nose, mouth, ears from the near-by desk top items while people stay a near-by place for a period of time including work, rest, sleep, stand. The details of each Figure show on the Fig's notes for details description.

It is appreciated the current invention has all above discussed co-pending or issued patent's drawing, details description and content are still been the parent filing of the current invention and all such drawing, detail description, contents should be still fall within the scope of the current invention and not limited to the current drawing, details description, content.

### DETAILED DESCRIPTION OF THE PREFERRED EMBODIMENTS

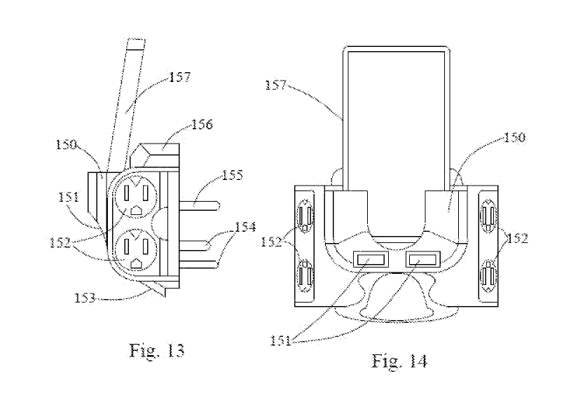

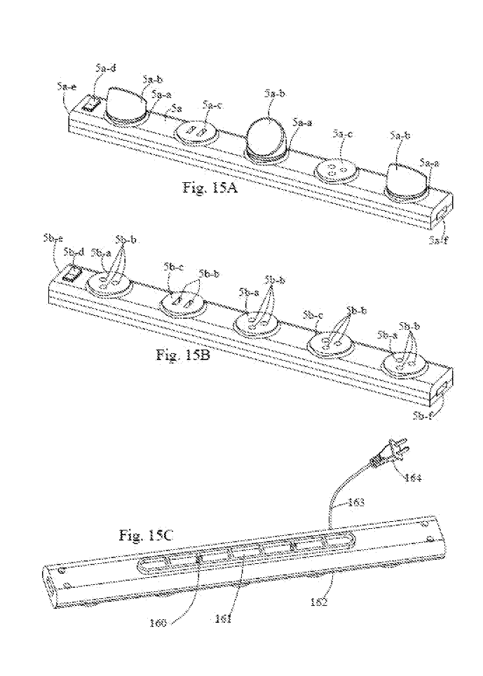

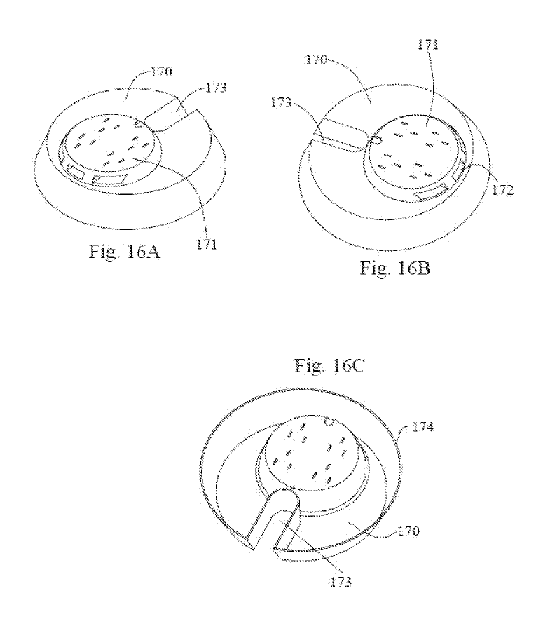

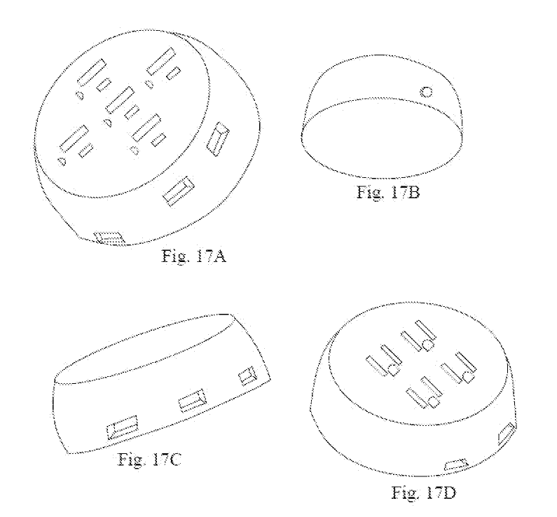

As shown in FIGS. 16A-20C,

The Housing means for the Power station or for assemble-unit can have model design to fit within or built-in on the desk top existing products. For this embodiment, The power station means has Outlet(s) and USB-Charger(s) with rotating features to change from Surface 1 to Surface 2. The different surface has different combination for LED-unit, Outlet(s), USB-Chargers as co-pending drawings and decals. The Housing means can allow lamp post to get into from open ditch so overlay to the lamp base.

The Housing means can design with Cut-Out Ditch like Fig (AAA) Fig (AAA-1) Fig (AAA-2), The Ditch can allow the Desk Lamp post to put near the hosing means center. The housing means can OVERLAY to the existing Desk Lamp base while contour of the Housing means has sufficient of the heights to allow the housing means fully overlay the existing Desk Lamp Base . . . . . So it will be very nice to NO OCCUPY or NO NEED TO FIND NEW SPACE on Desk Top surface to install the Power Station.

Also offer people for HAND-REACHABLE power station to supply USB Charger(s) and Outlet(s) Power and even has LED-unit on desired one of the surface(s) or all surface. The cut-out Ditch after install the POST of Desk lamp can have decorative piece or elastic soft material such as SPONGE to fill up or Other material has elastic and easily to fill up the empty space for cosmetic purpose.

From Fig (BBB) disclosure the

Extension cord as a Power station to install on the Desk surface incorporate with the attach-means, fix means, screw means, double side foam tape, glue means, or other conventional means to make the Power stating (Here as Multiple Charger(s) and Outlets power source EXTENSION CORD). The attach-means or fix-means, screw means, bracket means with screw, catcher means will overcome the Long and heavy electric cord's weight.

From Fig (CCC) and Fig (CCC-1) are preferred embodiment for Power station has 5 outlets(s) and 3 USB-Port from inner USB-Charger assembly to offer the Power from Outlet(s) and USB-Charger to other electric device. The unit has weight-means to help to overcome the Power station's electric cord's weight so can install on the Desk top without been moved or change position while the weight of electric-cord's apply to the power station.
From Fig CCC-2: Show out the Desk power stating has 2 outlet(s) and 3 USB-port from inner USB Charger for other embodiment. The heavy electric-cord did not show out.
From Fig CCC-3: Show out the 4 Outlets and 2 USB-Ports from inner USB Charger for 3rd embodiment, The heavy electric-cord did not show out !

From Fig DDD and Fig DDD-1 shown the power station is a rotatable products which has rotating means and fix-means and heavy-weight means to make this power station. The Rotating means make the different surface has different combination for Outlets(s), USB ports, LED-units. The USB ports come from inner USB Charger. The outlets may has surge protection or MOV circuit to make the device(s) been protected by ultra-high voltage input. Also, it may has some heat-ventilation means built-in for the power station. The heavy weight means can help the power station can not been pulled or moved by the very heavy electric cord's weight and make the power station fall down to floor or ground. This desk top power station can make people can use USB Charger, Outlets power source easily for hand-distance and no need to bend body to lower position or low-profile wall or ground for non-desktop Multiple functions or multiple charger extension cord which no desktop installation means.

From fig EEE and Fig EEE-1 show housing means has opening to allow install the Rotatable Power station and cut-out ditch to install the Lamp Post and with cosmetic-means to cover the ditch after finish installation The other features as co-pending case asn earlier drawing details desctription

From Fig FFF and Fig FFF-1 and Fig FFF-2

The preferred embodiment which housing means can add contour or edge-wall height so can fit for all kind of lamp base thickness. The inner has screw-thread to make the inner unit to raise to upper and make inner space become higher.

This can change the inner space to higher and higher so can fit all different thickness of the lamp base and make the housing means to overlay all market majority of the lamp base with sufficient height and overlay size/dimension. This is one of the preferred embodiment, The other market available adjust height, width, Radius still fall within the current invention scope for changeable 3 Dimension to allow the different size lamp base can fit within the current invention's housing means.

The current invention are continuously filing of co-pending filing U.S. Ser. No. 12/950,017(#CCC) Multiple surface LED light filed on Nov. 29, 2010 with rotating device has LED light device(s) and USB device and Outlets device built-in on the rotating substrate with more than one surface to offer multiple function.

The said U.S. Ser. No. 12/950,017(# CCC) is continuously filing for U.S. Ser. No. 11/806,285 (Inventor's #R) filed on May 31, 2007 which also a multiple functions LED light device which are the continuously filing of the U.S. Pat. No. 7,318,652 (Iventor's #B) for multiple function Wall Cover which filed on Mar. 31, 2005. The current invention also continuously filing of U.S. Pat. No. 7,651,365 (Inventor's #F) filed on Jan. 15, 2005 which is CIP of Oct. 1, 2004. It also the CIP of U.S. Pat. No. 7,810,985 (Inventor's # A) file on Mar. 3, 2005 but it is CIP of Oct. 1, 2004 filing date too. All these patented or pending case all related to the Light source with Outlets device(s) which are part of the current invention features and got US patents issues or co-pending. It is appreciated the all listed above patented or co-pending cases still treat as fall within the scope of current invention application and apply the priority terms for the current invention filing.

The current inventor also continuously filing for U.S. Ser. No. 13/161,643 filed on Jun. 16, 2011 for Desk-Top item with LED means has USB-unit(s) or USB-Module(s) to charge other electric or digital-data device.

The current invention also continuously filing for U.S. Ser. No. 13/117,227 filed on May 27, 2011 for Universal Module has USB-Unit(s) or/and Outlet-unit(s) for variety of electric or digital-data device.

The current invention are different with the US prior art including:
1. U.S. Pat. No. 7,736,033→The Lamp Base with Electric device recharge receptacle & means→The Bhart's disclosure the Outlest device and the Cigar lighter build on the lamp base. The LampaBase make the input AC current transfer to output current to automobile current (12 Volt), then the Automobile Cigareet make the input current from (12 VDC) to USB end current (5 Volt). This means the Bhart's device at least need 2 expensive circuit/Transformer to get the USB Charger's output current from (120 VAC wall outlets) to (USB Current 5 VDC). This is not economical and none of people need 12 VoltDC for house use at all.
   The current invention direct install the USB Charger unit which transfer the input-end 120 VAC to output-end 5 VDC so this is practically.
2. US Prior art→Public 2011-017703 Rotabel & concealable device which only has the outlets device with manual switch. This is directly for 120 VAC outlets power source directly though metal piece and delivery 120 VAC to the rotabel & concealable device's receptacles to offer 120 VAC current while the other device's plug means connect with the said receptacle.
   703 patent fail to disclosure the any USB charger concept, circuit, design and application so not have any related with the current invention for USB charger and the current invention device use Overlay to sit on existing lamp base to offer multiple power type power station with a lot of features.
3. US prior art: U.S. Pat. No. 7,897,277 Meyer et al, disclosure the Reversible battery cartridge which are use the AC batteries cartridge a the backup power for the all kind of lamp which mainly for power fail application.→This is nothing to do with USB ports and USB charger application. So there is totally different with current invention related to (1) USB ports+(2) USB Charging+(3) Outlet supply power source+(4) LED light and Universal lamp base to fit for all kind of existing lamp base so not occupy any new desk top space because (5) the Universal Desk base is overlay top of the existing lamp base.
Further more, the current invention has (6) LED light incorporate with the above listed (1) (2) (3) (4) (5) so it become a unique practical Universal Power station because (7) the current invention is not only supply one kind of power to charger different electric or digital-data device(s).
4. US prior art—U.S. Pat. No. 6,474,823 Disclosure the laptop computer with top illumination light which is not for the AC power source into USB related circuit to transfer to the DC current to charge DC 5 Volt electric device. The Computer input-end current is 120 VAC but it pass though the computer its transformer already transfer to output-end current at 5 VDC and then there is no any USB Charger circuit inside the computer so the computer's external transformer which directly to delivery 5 VDC current to the to the USB Port so the computer system which is not same as current inventions the input-end current is 120 VAC though USB Charger inside circuit to get the output-end for 5 VDC.
   The total circuit and concept is different because computer prior art use the EXTERNAL Transformer which not belong to computer itself parts to transfer the 120V Outlet power→Though EXTERNAL transformer get 5 VDC current (Outside the computer)→The Computer itself input-end current is 5 VDC and output-end current of USB ports also is 5 VDC so it proof, Computer itself is no any USB Charger circuit inside. The
   Input is 5 VDC and output also is 5 VDC so there is no any USB Charing same as current invention features for 1.0 Amp or 2.1 Amp or 3.1 Amp or more which also is impossible to get from Computer power tank. Because EXTERNAL TRANSFORMER maybe only offer 600 ma into, How the Computer can export more bigger current than its input current??

So it is clear the current filing for “Universal Power station for Lamp-Base” which has built-in (a) LED light means (b) Outlets means as the co-pending cases as above listed with optional (c) Rotating means (d) Lock means, (e) USB charger means which the input-end current are 120 Volt AC same as the house outlets current into the said USB charger means and the output-end of the USB charger means is 5 VDC means though the USB Charger means built-in circuit to change the current for designed 1.0 Amp/2.1 Amp/2.4 Amp/N-Amp or desired current Amperage with multiple-times or combination of the said 1.0 A/2.1 A/2.4 A/N-A (N—can be any number). This is not happen for any electric device or digital device can do from EXTERNAL TRANSFORMER which may already set for the device maximum power consumption such as LapTop which only get EXTERNAL Transformer output-end for 500 ma so all the LapTop computer may max. get into the Laptop so it is impossible to get more than 500 ma current to supply to USB Charger for 1.0 Amp/2.1 Amp/2.4 Amp/N-Amp or these number's any combinations for Desired Larger Amperage or Multiple times of these 1.0 A/2.1 A/2.4 A/N-A. Because input into laptop only 0.5 Amp how to supply for 1.0 A/2.1 A/2.4 A/N-A for larger than input current amperage ??

This show the current invention has major difference with other US prior arts including U.S. Pat. No. 6,474,823 for laptop computer which only can supply 0.5 Amp current which charge the smart photo take very long time, to Charger panel computer or iphone take almost days . . . . So this is not same as USB Charger for bigger current output than EXTERNAL Transformer applications.

Also different with the U.S. Pat. No. 7,736,033 which for 120 VAC (House current) to 12 VDC(Cigar lighter Automobile current) then use cigarete lighter's iner circuit to change from 12 VDC to 5 Volt DC (DC to DC). This is different and troublesome and costly wrong design for LampBase application. Also, Lack of all above listed (7) features.

The Other 2011-017703 Lin's Public case which for rotating and concealable for outlets device only with On-Off toggle switch which is filed tool late than current inventor's parent filling for U.S. Pat. No. 7,651,365 or U.S. Pat. No. 7,810,985 or U.S. Pat. No. 7,318,653 all these filing date on May 31, 2005 but 2 of 3 issued patents back to earlier Parent filing date on Oct. 1, 2004. So this is less creative than current earlier filling case and less features too.

The Other U.S. Pat. No. 7,897,277 or 2009-022-5486 or 2010-008-4651 all are too late than current inventor's May 31, 2005 filed now become U.S. Pat. No. 7,318,653, U.S. Pat. No. 7,651,265, U.S. Pat. No. 7,810,985 and all are less features than all these earlier patented features, so none as earlier filing than current inventor and also none of the other cases have more features, creative mind, new concept, new utility than current inventions.

The current invention very similar with the co-pending filing U.S. Ser. No. 12/950,017 and U.S. Ser. No. 13/161,643 and U.S. Ser. No. 12/117,227 so all the current filing drawing are directly copy these co-pending filing cases. The current invention just make the more discussion for US Prior arts basing on these (3) filing case examiners' listed prior arts. Current inventor made clear comparison and reason for all copending filing cases v.s. Examiner all prior US arts here.

The current inventor also had more features top of the co-pending (3) parent filing cases U.S. Ser. No. 12/950,017 and U.S. Ser. No. 13/161,643 and U.S. Ser. No. 12/117,227 including (Features 8) The current invention has Desk Top design for new drawing as Fig XX+1, and Desk Top with rotating unit as Fig XX+2, and DeskTop with rotating unit has overlay means to sit top of the existing lampbase as Fig XX+3, and desk top with non-rotating unit has overlay means as Fig XX+4 or the other applications, equivalent applications, upgrade application, similar concept application, or extend from current invention's applications still fall within the current invention's scope and claims not limited to current invention's drawings, Figures, embodiments, and contents.

The current invention has other (12) features as below:
1. The Power Station has LED & USB means for Desk Top installation consist of;

The power station means has at least one of the said of outlet(s), USB unit(s), LED unit(s) to assemble together to offer multiple power outputs including 110-250 VAC power source, 3.5-8.5 VDC power source and LED illumination at the same time.

The said USB unit(s) directly from inputted to transfer the range of 110-250 VAC house power to become 3.5-8.5 VDC output power for desire electric-current in group combination select from 1.0 A, 2.1 A, 2.4 A or other electric-current to allow the USB-unit(s) can have sufficient charging capability to charge the other electric or digital-data or Audio or Video Device in short time from output ends has 1.0 A, 2.1 A, 2.4 A, 3.1 A, 3.4 A, 4.2 A, 4.5 A, 4.8 A, 5.5 A or any other output power from desired Amperage.

The said Outlet(s) which connect with house 110-250 VAC range input power and supply the 110-250V range as output Power to the make other device(s) perform the desired functions with add electric means which may in group combination including master switch design, MOV design, surge protection design, overload design, over heating design. High voltage design.

The said LED-unit(s) are built-in or fit-in or within the said power station to offer the light illumination under pre-determined function(s), Performance(s), effect(s) while incorporated with IC, sensor means, switch means, remote control means, infra-red means, power fail means, flood-means or other electric or mechanical means.

The improvement including:

The said power station which means the power station may in any geometric shape, size, dimension alone or built-in the said other products and install on the desk top alone or incorporate with the existing desk top products such as desk lamp, more than one functions of extension cord with fix-means, juice maker, micro wave, coffee cup heater, wireless phone base, fax machine, copy machine, office machine, computer monitor, key pads, speaker, communication devices, consumer electric items, fax machine, Printer, scanners, or other device(s) people will use for desk top.

The said power station along or the desk top products means the said power station or desk top product(s) can put on the desk top and it will not be pulled, or be moved or be removed by the weight of the electric cord which it may be less than the 50 feets.

The said power station or the said products in the form of the desk lamp, 3 dimensional products, LED related products, USB charger related products, Outlets related products which need to incorporate with install-means may select from group combination from socketion cup, screw with catch means, phone holder, glue, Double side tap, magnetic means, catcher means, hoop-n-loop means, weight means so can overcome the weight of the said 120 VAC electric code which has very heavy gauge and heavy so have to use the said installation means so can keep the power station or product(s) solid stay on desk top and overcome the such long and heavy electric cord(s).

The Power station or product(s) may optional incorporate with rotating means, spin means, flip-over means to turn the 1^{st} surface to more than one surface(s) to hidden the outlets, USB-Unit(s), LED light unit(s) been seen by viewers and to prevent water, dust, ash to get into the receiving areas.
2. The Power Station has LED & USB means for Desk Top installation as 1, The said more than one functions of extension cord with fix-means which can install on the desk top and not be moved, be removed while the said electric cord weight apply to the said more than one function(s) extension-cord device.
3. The Power Station has LED & USB means for Desk Top installation as 1, The said power station may incorporate with housing means to apply to existing desk top items such as the desk lamp base, Audio speaker, printer, wireless phone base, book case with geometric shape with attachment means, add-on means, fix means, assembly means hanging means or other market available skill or method, to overlay or underlay to add on the desktop items.
4. The Power Station has LED & USB means for Desk Top installation as 1, The said housing means are designed to fit into the existing desk top items which is a Desk Lamp base to overlay or underlay not to occupy more space of limited desk top space but has power station multiple charging functions without operate charging near ground or low-profile area to prevent people to bend body.
5. The Power Station has LED & USB means for Desk Top installation as 1, The said the said housing means are design to fit into the existing desk top items which is a desk top computer related products including monitor, key pad, Printer, scanner which can install the power station on its base, or any surface.
6. The Power Station has LED & USB means for Desk Top installation as 1, The said the said housing means are design to fit into the existing desk top items which is a communication products including wireless phone base, wireless phone bracket to install the power station on its base, or any surface.
7. The Power Station has LED & USB means for Desk Top installation as 1, The said desk top housing means are design to fit into the existing desk top items which is a consumer electric or electronic device such as Time piece, cup heater, TV, Desk Lamp, coffee machine, tea pot, electric tools, hair dryer, lighted mirror, cosmetic mirror with light, music box, fan, heater, air purifier or any other consumer electric products.
8. The Power Station has LED & USB means for Desk Top installation as 1, The said desk top housing means are design to fit into the existing desk top items which is a charger sets, extension cord device, multiple functions chargers.
9. The Power Station has LED & USB means for Desk Top installation as 1, The said desk top housing means are design to fit into the existing desk top items which the housing means has at least one of material with preferred parts and accessories to form good appearance to let people willing to install on the top of desk surface.
10. The Extension cord has Outlet(s) & USB-Charger(s) for Desk Top installation consist of;

At least one outlet and USB-charger(s) are design on the body which has preferred electric cord has its safety certification and length to connect to the power source by prong-means and can have fix-means, attach-means, weight means, magnetic means, screw and holder means, catcher means, assemble-means to install the said extension cord's body on the desk top or desk's design surface(s) where are people hand can reachable do not need bend the body to work at ground area.

The said extension cord's body can overcome its cord's weight and do not be moved while the extension cord's prong-means connect with power source.

The said extension cord's electric cord has length from 0.5 to 50 feets long and its electric cord has gauge between #12 to #18 basing on safety requirement. The said USB unit(s) directly from inputted to transfer the range of 110-250 VAC house power to become 3.5-8.5 VDC output power for desire electric-current in group combination select from 1.0 A, 2.1 A, 2.4 A or other electric-current to allow the USB-unit(s) can have sufficient charging capability to charge the other electric or digital-data or Audio or Video Device in short time from output ends has 1.0 A, 2.1 A, 2.4 A, 3.1 A, 3.4 A, 4.2 A, 4.5 A, 4.8 A, 5.5 A or any other output power from desired Amperage.

The said Outlet(s) which connect with house 110-250 VAC range input power and supply the 110-250V range as output Power to the make other device(s) perform the desired functions with add electric means which may in group combination including master switch design, MOV design, surge protection design, overload design, over heating design. High voltage design.
11. The Power station has Outlet(s) and USB charger(s) for desk top installation consist of;

At least one outlet(s) and USB-charger(s) are design on the body which has preferred electric cord has its safety certification and length to connect to the power source by prong-means and can have fix-means, attach-means, weight means, magnetic means, screw and holder means, catcher means, assemble-means to install the said Power station's body on the desk top or desk's design surface(s) where are people hand can reachable do not need bend the body to work at ground area.

The said Power Station's body can overcome its cord's weight and do not be moved while the extension cord's prong-means connect with power source.

The said Power Station's electric cord has length from 0.5 to 50 feets long and its electric cord has gauge between #12 to #18 basing on safety requirement.

The said USB unit(s) directly from inputend to transfer the range of 110-250 VAC house power to become 3.5-8.5 VDC output power for desire electric-current in group combination select from 1.0 A, 2.1 A, 2.4 A or other electric-current to allow the USB-unit(s) can have sufficient charging capability to charge the other electric or digital-data or Audio or Video Device in short time from output ends has 1.0 A, 2.1 A, 2.4 A, 3.1 A, 3.4 A, 4.2 A, 4.5 A, 4.8 A, 5.5 A or any other output power from desired Amperage.

The said Outlet(s) which connect with house 110-250 VAC range input power and supply the 110-250V range as output Power to the make other device(s) perform the desired functions with add electric means which may in group combination including master switch design, MOV design, surge protection design, overload design, over heating design. High voltage design.
12. The desk-top product has a assemble-kits which has built-in USB charger(s) and Outlet(s) consist of;

At least one outlet(s) and USB-charger(s) are design on to fit within the assemble-kits which has preferred electric cord has its safety certification and length to connect to the power source by prong-means and can have fix-means, attach-means, weight means, magnetic means, screw and holder means, catcher means, assemble-means to install the said assemble-kits to the product's body for the desk top or desk's design surface(s) to use to let people hand can reachable do not need bend the body to work at ground area.

The said product's body can overcome assemble-kit's cord weight and do not be moved while the extension cord's prong-means connect with power source.

The said assemble-kit's electric cord has length from 0.5 to 50 feets long and its electric cord has gauge between #12 to #18 basing on safety requirement.

The said USB unit(s) directly from inputend to transfer the range of 110-250 VAC house power to become 3.5-8.5 VDC output power for desire electric-current in group combination select from 1.0 A, 2.1 A, 2.4 A or other electric-current to allow the USB-unit(s) can have sufficient charging capability to charge the other electric or digital-data or Audio or Video Device in short time from output ends has 1.0 A, 2.1 A, 2.4 A, 3.1 A, 3.4 A, 4.2 A, 4.5 A, 4.8 A, 5.5 A or any other output power from desired Amperage.

The said Outlet(s) which connect with house 110-250 VAC range input power and supply the 110-250V range as output Power to the make other device(s) perform the desired functions with add electric means which may in group combination including master switch design, MOV design, surge protection design, overload design, over heating design. High voltage design.

The Below for the Original Detail description which #CCC copy from Co-Pending U.S. Ser. No. 12/950,017.

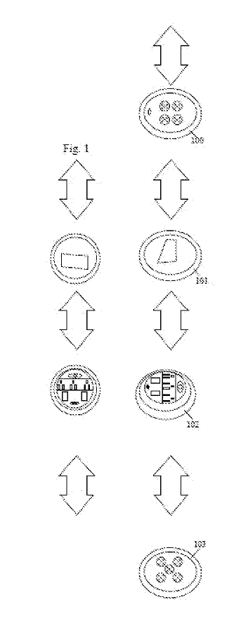

FIG. 1: Disclosure the 1^{st} preferred embodiment for Multiple surface(s) LED light (1A) which has 1^{st} surface has LED element(s) recess installed on. While the external force apply to the LED light and make it rotate (1B) to turn to the 2^{nd} surface (1C) and fix on position (1C) by lock means to offer people the outlets for power source and Internet socket and phone socket (1C) to let people has convenient function on same location of the said LED light. The multiple surface LED light (1C) can continue to make rotate to get the 1^{st} surface (1D) while external force apply to the LED light (1C). so it can be continuously to make rotate along the bars (not shown). The details each steps of the multiple surface LED light as the illustration on the each brief notes.

The single location of the surface can have multiple electric application(s) as the FIG. 1 shown, It will save a lot of space especially for working table or under cabinet light fixtures. The FIG. 1 has all brief illustration for quickly understanding.

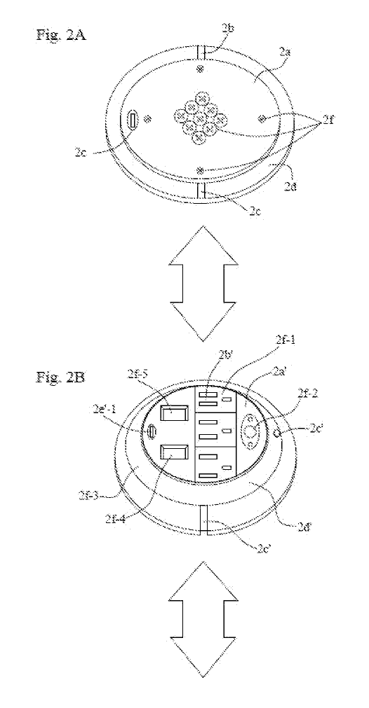

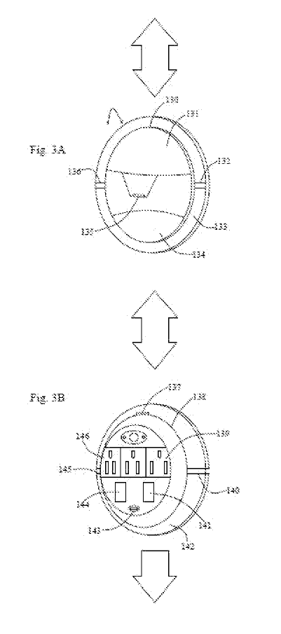

FIG. 2 and FIG. 3: Disclosure the one of application for 1^{st} preferred embodiment while the said multiple surface(s) LED light been apply to ceiling, walls, door, surface by itself without any other main objects or substrates or housing means. The said itself means the multiple surface LED light are directly install for building, house, Big furniture, such as ceiling, wall, door, closet, cabinet not like the power strips, LED light fixture, Light device, light bars.

The all parts and accessories to make such multiple surfaces LED light as drawing. From FIG. 2 can see the 1^{st} surface (2a) has plurality LED(s) or LED dot matrix array for LED sets (2f) to install on the 1^{st} surface (2a) and has its two bars on the top (2b) and low (2c) to make the said LED light can be rotate along the two extend bars (2b) (2c). The two extend bars also have inner channel to make the electric signal delivery from the other ends into the LED light which may use co-inventor's prior electric connections as attached drawing Page 8 to page 13 or use conventional art of skills to make the electric signal delivery. The lock means (2e) which can lock the LED light on different surface so can keep there solid without change the surface to other surface. For example while the LED light on the (2B) position if without the lock means it will be easily to pushed and make rotate to change position, so it will be very danger because people may insert prong means into the outlet socket(s) (2f-1). The lock means (2e) (2e′) (2e′-1) not only for lock means but also act as release means to make the LED light can change from 1^{st} surface to other surfaces while needed. The other surface (2a′) may has the outlets sockets (2f′-1), Internet sockets (2f′-5), Phone sockets (2f′-4), Sensor means (2f′-2) on 2^{nd} surface (2a′) so it can be offer people very convenient LED light with multiple function while it change surface(s).

From FIG. 3 show more simple drawing for the construction of the said FIG. 2 of LED light on the 1^{st} surface how to make it change surface (3A) and other surface (3B). All parts with details name on drawing so it can be easily double check the LED light shown on FIG. 2 of 1^{st} surface (2A) and other surface (2B).

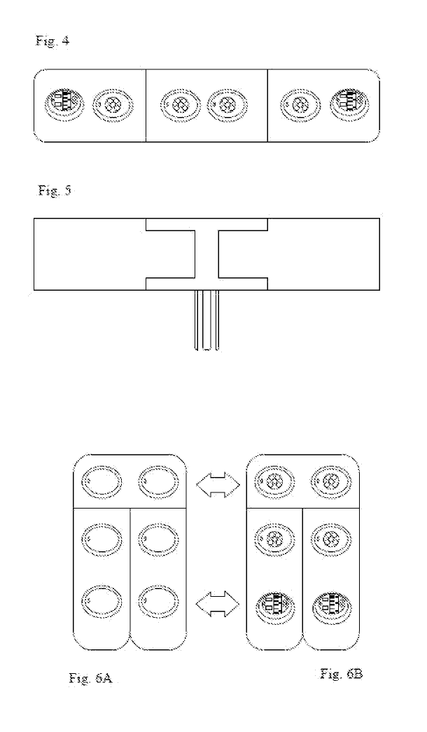

From FIG. 4 and FIG. 5 and FIG. 6A and FIG. 6B and FIG. 7 and FIG. 8 and FIG. 9: These preferred embodiments show the multiple surface LED light are not apply to itself to ceiling, walls, surface of building or house. These preferred embodiment show to apply the multiple surface LED light on existing electric products which will be out of date while all these

Existing electric products change its old concept to current invention. From the FIG. 4,5,6A,6B,7,8,9 all related for existing LED light bar or Outlet devices or extension cord or power strips which only had simple function. From all these drawing show the top view of one of the foldable wall outlet device or foldable extension cord which same as co-inventor's U.S. Pat. No. 7,824,185, But this foldable concept also same as co-inventor's U.S. Pat. No. 7,726,841 for foldable LED light fixture. However, both prior arts is limited to the Outlet device or LED light. Now the current invention to make the “multiple surface LED light” to replace the prior application's simple “LED-unit” or “outlet-unit” so can make more practically products not only offer the LED light but also outlet or more with internet, phone, motion sensor or other any electric function(s) top of co-inventor's prior simple functions electric device. It is appreciated the existing electric products means any electric products which is not apply the current invention's multiple surface LED light on it still fall within the current invention scope while all existing electric products incorporate with current invention's multiple surface LED light on it should be belong to current invention's claims.

FIG. 4, FIG. 5, FIG. 6A, FIG. 6B, FIG. 7, FIG. 8, FIG. 9, FIG. 10, FIG. 10A, FIG. 10B, FIG. 11: Disclosure the one of the application for the 1^{st} preferred embodiment while the said multiple surface(s) LED light been apply to the other main objects or other substrate or other hosing means which

the said main objects or substrate or housing means is a individual existing products available at market place which maybe a power strips, light fixture, extension cord (co-inventor's U.S. Pat. No. 7,824,185), wall outlet device, LED light device (as co-inventor's U.S. Pat. No. 7,618,150), foldable device, extendable device (as co-inventor's (U.S. Pat. No. 7,722,230), removable device (as co-inventor's U.S. Pat. No. 7,726,839), Transforming device (as co-inventor's U.S. Pat. No. 7,726,841). All these existing products while change the construction or design, then, It will become a very useful and practically items because it will be multiple function(s) than original products which should be make more valuable for peoples.

From FIG. 10: show the other existing electric products (It is appreciated the existing electric products means any electric products which is not apply the current invention's multiple surface LED light on it still fall within the current invention scope while all existing electric products incorporate with current invention's multiple surface LED light on it should be belong to current invention's claims). From FIG. 10 show is one existing extension cord or power strips but has current invention's multiple surface LED light on it. Basically, the power strips has the certain specification for outlet-unit, but add a LED light on the said out-let unit will only increase a limited thin thickness because we can use LED chip which only certain mini-meters so to make a multiple surface LED light with Outlet on other surface its dimension almost same as only outlet-unit power strip. But it will be big increase the functions. For example, All power strips or extension cord can add the LED elements on 1^{st} surface and keep the original outlet-units of power strips or extension cord so it will become a under-cabinet LED light unit and people can change some LED light to become the outlet-units so can have light performance and outlets for other electric device. It will be good.

From FIG. 10 and FIG. 10A and FIG. 10B, show all possibility for 1^{st} surface of its LED element arrangement as FIG. 10A. It also show all possibility arrangement for other surface as FIG. 10B. The FIG. 10 show the one of preferred embodiment for multiple surface LED light on existing electric device (here as power strips or extension cord but has current invention's multiple surface LED light(s) on) . . . . All brief illustration and description on the drawing for easily and quickly understanding.

From FIG. 11 show the Other preferred embodiment. The round power strips or extension cord which has plurality of the said multiple surface LED light (11-2) (11-3) (11-5) (11-6) on its surface (11-1) and each of the LED light (11-2) (11-3) (11-5) (11-6) has its LED elements for different style, thickness, shape, brightness, color, control means, circuit, turn-on/turn-off timing, sensor means, switch means, power output etc. Each of these multiple surface LED light can change surface individual and change from (11-5) to (11-7) and Change from (11-6) to (11-11) and change from (11-2) to (11-9) and change from (11-3) to (11-10). The center unit (11-4) is not the “multiple surface LED light”. The side drawing show how the said multiple surface LED light (11-2) (11-3) (11-5) (11-6) can be change from (11a) rotate to (11-b) rotate to (11-c) and rotate to (11d) so it is clear for how to operated the change surface from 1^{st} one to other surface by external force which may by people or by motor for automatically design or remote control design (wireless) or other mechanical design depend on market requirement.

Page 8 to Page 13: Disclosure the co-inventor's prior application for how to make electric signal delivery from the one end to other end which can be rotate or twist or movable but still have good electric connection and delivery from one end to other ends. It also appreciated the current invention apply the conventional market available skill to make the electric delivery from one end to other end.

It is appreciated that all the above discussion, drawing, illustration, co-inventor's prior application and its alternative, same function, equivalent method or improvements still fall within the current invention scope for multiple surface LED light to apply by itself to wall, ceiling, door, closet or incorporate with other main objects, other substrates, other housing means. Any LED light which has more than one surface and can change to other surface(s) will be fall within the current invention.

The Below for the Original Detail description which #FFF copy from Co-Pending U.S. Ser. No. 13/117,227

From the parent filing cases of the above listed. This application is Continuously filing for U.S. Ser. No. 12/502,661, U.S. Ser. No. 12/292,580, U.S. Ser. No. 12/566,322, U.S. Ser. No. 11/498,874, U.S. Ser. No. 11/527,629, U.S. Ser. No. 12/622,000, U.S. Ser. No. 12/624,621 which disclosured the sealed-unit with uniform dimension of shape to fit into the same uniform dimension of compartment to put the universal sealed-unit fit into variety of LED light device. This invention has more features and functions and effects to allow the people to buy any electric device or digital data devices has more practically additional functions, features, convenient including has the outlet-unit(s) to supply the 1^{st} or more different electric power to other device(s) or has USB-unit(s) to supply the 2^{nd} or more different electric power to other device(s). The current invention use universal module which can has any combination of following parts or accessories to make the said preferred module selected from group combination from related circuit-means, conductive-means, contact-means, receiving-means, output-ends, input-ends, electric parts and accessories, prong means, rotating means, cable means with plug, cable means with USB-plug, printed circuit means, Flexible printing circuit means, wires, cable, digital data cable, conductive plate, or any related electric parts or accessories available from market place so can get the electric power from the prong-cable means or USB-Cable means or prong means or USB means to the outlet-unit's or USB-Unit's receiving-means and let variety of electric device(s) get the said power.

The said Universal Module which equivalent or same function as other copending filing for the said “Sealed-unit” for the “LED light device” such as the co-inventor's issued U.S. Pat. No. 7,726,839, U.S. Pat. No. 7,726,841, U.S. Pat. No. 7,726,869, U.S. Pat. No. 7,618,150, U.S. Pat. No. 1,722,230 and Co-pending case U.S. Ser. No. 12/073,889, U.S. Ser. No. 12/894,865, U.S. Ser. No. 12/003,809 or the said “Outlet device” such as Co-inventors U.S. Pat. No. 7,824,185 which the “Sealed-Unit is a outlet-unit”. Further more the said “Sealed-unit or Battery-Pack” of the co-inventor's co-pending case U.S. Ser. No. 12/622,000 and above listed related parent filing cases some has the concept of the “Interchangeable power source which also is said the Sealed-unit”.

From Fig S, The current invention has the (A) shown the Universal Module which has the USB-unit has cable with USB-plug which has build-in 2 USB-Unit(s) and 2 Rotatable Outlet-units to form a Universal module. The each USB-unit has pre-determined power output though inner build-in circuit and related parts and accessories. The said 2 Rotatable Outlet-units which same as the details drawing of U.S. Pat. No. 7,824,185 drawing sheet page 5+6+7+8 (not attached) to disclosure how to make the said Outlet-unit can be rotating.

Form Fig S drawing B can see the Universal Module has same function as drawing A, but different is the USB-unit has the cable with prong-plug.

From Fig S, drawing C show the same function as drawing A and B but the this use the wall prong means to get the power directly from Plug the prong means into outlet without the cable like drawing A or drawing B.

From Fig S drawing D and drawing E and drawing F show the different input end of the said Universal Module so can meet all market requirement such as drawing D show the cigarette plug so can allow people to get power while they driving, drawing E show the other power source such as solar power, wind power, chemical power, generator, transformer, solar module, USB-means, or other any kind of power source with any other market available power deliver-method or means still fall within the current invention scope.

From Fig S drawing G, H, I, J, K, show the all different combination for the outlet-unit(s) and USB-unit(s) from 1 to N number with desired power In-put and Power output which discussed above as point (9).

From Fig S drawing Q, R, K which has more than one outlet-unit(s) which can selected one of the outlet-unit as Master and it will turn-on or turn-off other outlets basing on the said THE ONE MASTER Outlet. This is very good function for any computer system. For example, while turn on Computer, the related printer, scanner, hub, USB-hard disc, speaker, reading light, hard-disc, other computer related parts and accessories to turn-on and turn-off while main master outlet-unit been activated.

From Fig S drawing Q, R, K while the Wall prong means change to the said Cable-with-plug or Cable-with-USB plug which means it is a traditional Extension cord for 120 Volt 60 Hz or USB-Port power cord which will be same function or equivalent function with the drawing Q, R, K, so it has cable or without cable for power strips (Power cord) or Wall direct plug in (Wall outlet) still fall within the current invention scope. It is appreciated for this equivalent or same functions means.

From Fig S drawing L, M, N, Q, R disclosure the different application for the said Universal Module with any desired combination of USB-unit(s) or Outlet-unit(s) for variety electric device(s) or digital data device(s) including indoor, outdoor such as desk lamp, wall adaptor, wall outlet, extension cord or any other electric device(s) or digital data device(s). The major difference between the current invention v.s. all market available device(s) are at the current invention has got the all related safety certification for said the Universal Module so can directly add the Universal Module into any existing electric device(s) or digital data device(s) and no need to file other UL, CSA, ETL or any laboratory test while move into product into market.

The said Universal Module has its very important feature to get the all related safety certification and can instant add into all existing device key at the said module have the one output-end which can connect with existing product's power input-end, so allow the existing power input-end can connect with the Universal output-end, so it is very simple to add the said Universal Module into any existing electric device(s) or digital data device(s) to save a lot of time, money, procedure, application, human resource to file the related safety standard by individual products.

This is the Key issues.

From The above discussion the current invention has the fatal improvement including:

At least one Universal Module has desired combination for outlet-unit(s) or USB-Unit(s) build-in with desired power-out-put end(s) and power-in-put end (s) to get the power or supply the power to the other electric device(s) or digital data device(s).

The said outlet-unit(s) or USB-unit(s) which has any combination of following parts or accessories to make the said preferred unit selected from group combination from related circuit-means, conductive-means, contact-means, receiving-means, output-ends, input-ends, electric parts and accessories, prong means, rotating means, support means, holder means, adjustable length or wide means for holder means, LED light means, or other light means, cable means with plug, cable means with USB-plug, printed circuit means, Flexible printing circuit means, wires, cable, digital data cable, conductive plate, transformer, inductor, diodes, capacitor, resistor, transistor, resistor, inverter, surge protective circuit, Ginar diode, IC, integrate circuit, or any related electric parts or accessories available from market place so can get the electric power from the prong-cable means or USB-Cable means or prong means or USB means to the outlet-unit's or USB-Unit's receiving-means and let variety of electric device(s) get the said power.

The said Universal Module has passed all safety standards and got its own safety certification or got the said universal module at least as recognized-parts with its own power-out-put end(s) to allow to supply the power to original existing electric device(s) or digital data device(s).

The said outlet-unit(s) or/and USB-unit(s) can incorporated with IC means or switch means, control means which may selected by group combination from switch, motion sensor, infrared remote control, remote controller, timer, time delay, dimmer IC, master control system to control all other outlets of multiple outlets device(s), or any IC chip with special function to make the said Outlet-unit(s) or USB-Unit(s) to turn-on, turn-off under predetermined function, time, duration, period time.

These main features can turn all existing electric device(s) or Digital devise(s) can incorporate with current invention's Universal Module so turn all market available items has added practical functions than before.

FIG. 1 and FIG. 2: Disclosure 2^{nd} preferred embodiment which has build in Universal module has outlet-unit(s) or USB-unit(s) for the 2^{nd} embodiment which has the build in LED light, Outlet-unit(s), USB-unit(s), Holder means, Support means, prong means or cable means with plug to make the said wall-outlets or wall-adaptors or extension-cord (while incorporate with cable means with plug) can offer USB-charger or 120 Volt 60 HZ or other electric power to people for very practical products.

FIG. 3, 4, 5: Disclosure the preferred 3^{rd} embodiment which has the different high and low outlet-unit(s) or/and USB-unit(s) on one power strips which can also put the other electric device(s) on the lower outlet-unit(s) or USB-unit(s) to become some special design multiple functions power strips. It can be powered by battery as FIG. 4 or use cable with prong-plug as extension cord or power strip. The each of the Outlet-unit(s) or USB-unit(s) can be rotatable if market required as co-inventor's issued or co-pending filing cases. To apply the Universal Module of current invention will be most simple to change from Original outlets or LED-sealed units to multiple functions devices.

FIG. 6: Disclosure the co-inventor's co-pending U.S. Ser. No. 12/938,628 for the outlet-units with rotatable orientation features. It can be direct plug-in wall to get power or use cable-prong-plug as existing extension cord/power strips to get power away from the wall or outlets device(s). The current invention just arrange some outlet-unit(s) to become the USB-Unit(s) so can have extra functions, features. To apply the Universal Module of current invention will be most simple to change from Original outlets or LED-sealed units to multiple functions devices.

FIG. 7,8,9: Disclosure the co-inventor's co-pending fling U.S. Ser. No. 12/938,638 drawing which also shown on issued U.S. Pat. No. 7,824,185 for the transformer outlet device or LED light device. Now, add some USB-units on the some preferred position with rotatable USB-unit or fix-angle USB-units will increase the features of co-pending or issued patents function. To apply the Universal Module of current invention will be most simple to change from Original outlets or LED-sealed units to multiple functions devices.

FIG. 10, 11, 12, 13, 14, 15: Disclosure the different power source for variety consumer electric device(s) which can add the USB-unit or Outlet-unit as required too. Especially the FIG. 13 show the extension cord or power strip which has plurality of the outlets and USB-Unit. The most important the this preferred embodiment contain the “Mater control function” which means while the outside electric device(s) plug into the master control outlet and turn on/off the said electric device(s), The master outlets will be activated and turn on/off all the other outlet(s) or USB-unit(s) so can save people to turn on/off each other outlet's related electric device(s). It also will turn off all the other outlets or USB-Unit power while the said Master control outlets been disconnect with the said other electric device.” This is the other features can add top of the said current Universal Module has outlet-units or/and usb-units

Further more, the current inventions also has following features which has more details discussion on co-inventor's co-pending filing cases which still should be within the current invention scopes not limited for current drawing, details description, content for examples for all below limited points;

3. The Universal Module has USB-unit(s) or Outlet-unit(s) for variety of electric device(s) or digital data device(s) as Claim 1, the said extension cord has the outlet-units or/and usb-units has the master control features while the master control outlet-unit's connect with other device(s) for turn-on and turn-off power, The all other outlets-units or/and Usb-Units will become turn on and turn-off as the master control outlet-unit condition.

4. The Universal Module has USB-unit(s) or Outlet-unit(s) for variety of electric device(s) or digital data device(s) as Claim 1, the said the universal module can be turn on and turn off by electric or mechanical switch means, sensor means.

5. The Universal Module has USB-unit(s) or Outlet-unit(s) for variety of electric device(s) or digital data device(s) as Claim 1, the said the universal module can has desired number and combination of the said LED sealed unit, outlet-unit(s), usb-unit(s) with rotatable features or fix angle features.

6. The Universal Module has USB-unit(s) or Outlet-unit(s) for variety of electric device(s) or digital data device(s) as Claim 1, the said universal module can connect with the existing electric device(s) or digital data device(s) by outlets means, soldering means, contact means, plug into means, snap together means or the skill of the conventional market means to build the electric delivery from the universal module to the said existing device(s) or digital data device(s).

7 The Universal Module has USB-unit(s) or Outlet-unit(s) for variety of electric device(s) or digital data device(s) as Claim 1, the said universal module can be sealed by glue, chemical seal means, compound, liquid to prevent from electric shock for any live wires.

8. The Universal Module has USB-unit(s) or Outlet-unit(s) for variety of electric device(s) or digital data device(s) as Claim 1, the said electric device(s) or digital data device(s) including Desk lamp, wall outlet, extension cord, power strips, generator, solar power module, wind power device, transformer device.

9. The Universal module has USB-Unit(s) or/and outlet-unit(s) for variety of electric device(s) or digital data device(s) as Claim 1, the said recognized-parts means the universal module been tested by laboratory for all safety related standard and can be sell the said universal module as a parts or accessories to allow to install on any other products or main objects.

The Below for the Original Detail description which #GGG copy from Co-Pending U.S. Ser. No. 13/161,643.

The current invention is Continuously filing of U.S. Ser. No. 13/117,227 for “Universal Module has USB-unit(s) or/and Outlet-unit(s) for electric or digital device(s)”

From the parent filing cases of the above listed. This application is Continuously filing for U.S. Ser. No. 12/502,661, U.S. Ser. No. 12/292,580, U.S. Ser. No. 12/566,322, U.S. Ser. No. 11/498,874, U.S. Ser. No. 11/527,629, U.S. Ser. No. 12/622,000, U.S. Ser. No. 12/624,621 which disclosured the sealed-unit with uniform dimension of shape to fit into the same uniform dimension of compartment to put the universal sealed-unit fit into variety of LED light device. This invention has more features and functions and effects to allow the people to buy any electric device or digital data devices has more practically additional functions, features, convenient including has the outlet-unit(s) to supply the 1^{st} or more different electric power to other device(s) or has USB-unit(s) to supply the 2^{nd} or more different electric power to other device(s). The current invention use universal module which can has any combination of following parts or accessories to make the said preferred module selected from group combination from related circuit-means, conductive-means, contact-means, receiving-means, output-ends, input-ends, electric parts and accessories, prong means, rotating means, cable means with plug, cable means with USB-plug, printed circuit means, Flexible printing circuit means, wires, cable, digital data cable, conductive plate, or any related electric parts or accessories available from market place so can get the electric power from the prong-cable means or USB-Cable means or prong means or USB means to the outlet-unit's or USB-Unit's receiving-means and let variety of electric device(s) get the said power.

The said Universal Module which equivalent or same function as other copending filing for the said “Sealed-unit” for the “LED light device” such as the co-inventor's issued U.S. Pat. No. 7,726,839, U.S. Pat. No. 7,726,841, U.S. Pat. No. 7,726,869, U.S. Pat. No. 7,618,150, U.S. Pat. No. 1,722,230 and Co-pending case U.S. Ser. No. 12/073,889, U.S. Ser. No. 12/894,865, U.S. Ser. No. 12/003,809 or the said “Outlet device” such as Co-inventors U.S. Pat. No. 7,824,185 which the “Sealed-Unit is a outlet-unit”. Further more the said “Sealed-unit or Battery-Pack” of the co-inventor's co-pending case U.S. Ser. No. 12/622,000 and above listed related parent filing cases some has the concept of the “Interchangeable power source which also is said the Sealed-unit”.

From FIG. 1 disclosure the 1^{st} preferred embodiment front view of the desk top items with LED means has USB-unit(s) to charge other electric or digital data device(s) which has 2 USB-units and 1 outlet-unit on front view. The said 1^{st} preferred embodiment is a 12 LEDs USB powered light and powered from the USB plug-wire means.

From FIG. 2 disclosure the 1^{st} preferred embodiment side view of the desk top items with LED means to charge other electric or digital data device(s) which has the 1 USB-unit and 2 outlet-units on the side of the base. The said 1^{st} preferred embodiment is a 12 LEDs USB powered light and powered from the USB plug-wire means.

From FIG. 3 disclosure the 2^{nd} preferred embodiment for 1^{st} desired design which has 3 USB-unit(s) with different power output to charge the different electric or digital data device(s). The USB-unit(s) may has 500 ma, 1,000 ma, 2,100 ma to charge different electric or digital data device(s) such as iphone and ipad for different requirement for charging current.

From FIG. 4 disclosure the 2^{nd} preferred embodiment for 2^{nd} desired design which has 2 USB-units and 1 outlet-unit so can allow people to charge or supply power source to the ipad, iphone and power the laptop computer or other device which can get power from the said USB-unit(s) or Outlet-Unit. From drawing it also show the difference and comparison between the embodiment #1 and #2 with details difference. All such Alternative, improvement, equivalent function, replaceable, similar functions still fall within the current invention and co-inventor's prior art as discuss on this filing case also fall within the current invention scope.

From FIG. 5 disclosure the 3^{rd} preferred embodiment of the desk top item which is a LED lighting fixture with adjustable arms to make the LEDs lamp for desired height, orientation, direction, angle so can get best illumination to people. The build-in 1 USB-unit and 1 outlet-unit which has lower cost than other above discuss with plurality of USB-units and Outlet-units. The desk top item powered by the transformer from wall outlets for 120 Volt AC current which is different from the Preferred embodiment #1 which powered by the USB plug & Wire. The 2^{nd} preferred embodiment powered by UL listed adaptor. The current powered by 120 Volt Wall Power though the transformer.

From FIG. 6 disclosure the #4 preferred embodiment which are powered by Solar power and storage the solar electricity inside the rechargeable batteries so can have enough power to charge other electric or digital data device(s) though the build-in USB-unit (s) and Outlet-unit(s) incorporated with proper circuit means so can meet Market requirement.

From FIG. 7 disclosure the #4 preferred embodiment which use Solar power, It is appreciated that the said items can be powered by any market available power source including group combination selected from solar power, wind power, chemical power, batteries power, generator, transformer, adaptors, inverter, inductor etc.

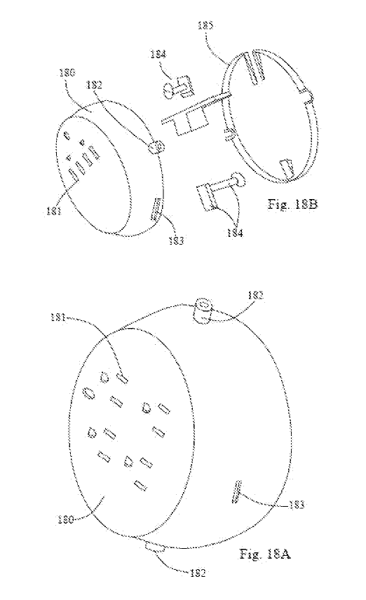

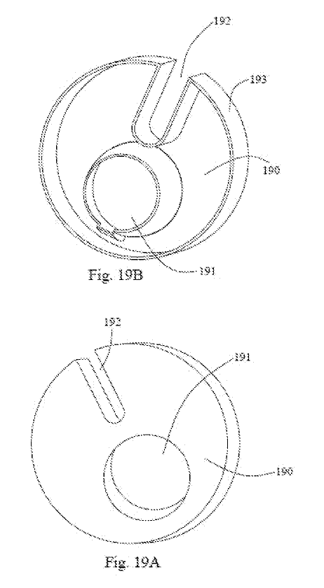

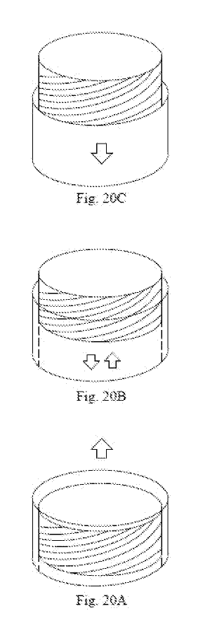

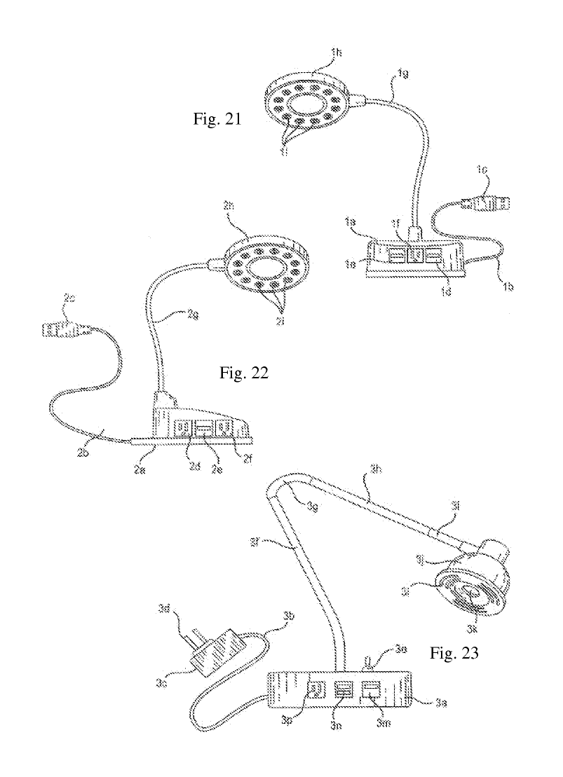

From FIG. 8 disclosure the base of the 1^{st} preferred embodiment which has thicker or higher base which can have bigger space to arrange the bigger size electric parts & accessories so can save a lot of cost for super compact, slim, cute size of the electric parts & accessories. Further more, the thicker or higher base which also can load the rotating USB-unit(s) or USB-Module so can keep the 1st surface of USB-Module look nice while not use the said USB-unit(s) or USB-Module which location on the 2^{nd} surface of the USB-Module. This embodiment details description also show on the drawing FIG. 8 for plurality of USB-units and other numbers of the said receiving means on the said 2^{nd} or more surface of the said USB-Module. This details rotating USB module details can seen from the FIG. 18, FIG. 19, FIG. 20, FIG. 21, FIG. 22 can see all very details descriptions, illustration which also can check from co-inventor's co-pending filing case U.S. Ser. No. 13/117,227 for all details too. It is appreciated all co-inventor's co-pending filing case's all illustrations, drawing, figure, background, details description and its alternative, same function, equivalent skill, improvement, upgrade still fall within the current invention.

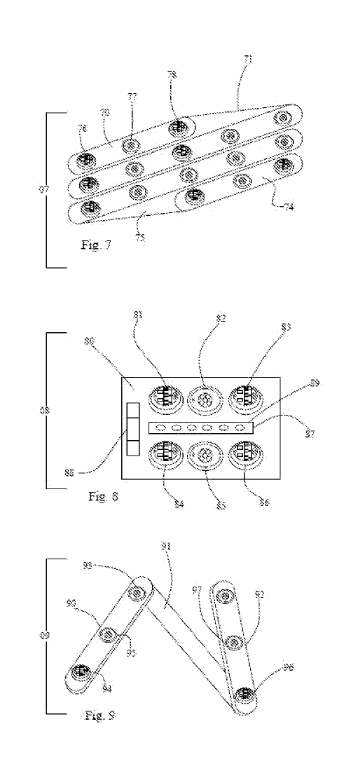

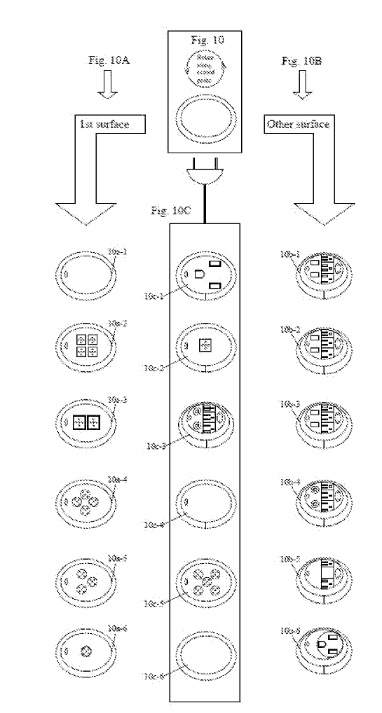

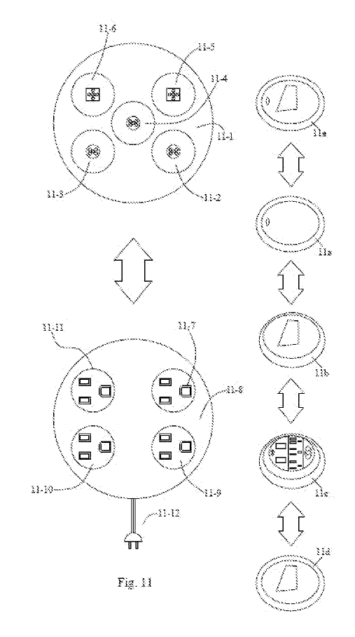

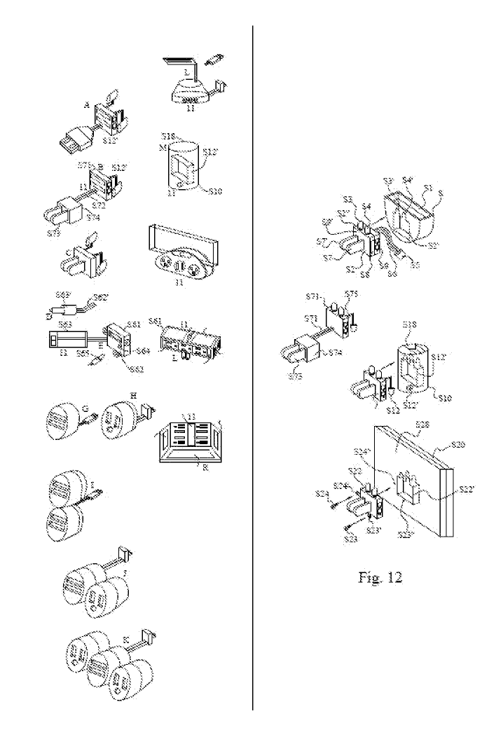

From FIG. 9 and FIG. 10 and FIG. 11 and FIG. 12 show the preferred #5 and #6 embodiment which has thicker or higher base of the said Desk Top Items with LED means, so can add the rotating USB-modules which has plurality of USB-Unit(s) and plurality of other receiving means to increase more function(s), feature(s), effects, performance(s). The said USB-Module has at least more than 1 surface so can change the desired surface for certain purpose. The said more than 1 surface of the said USB-Module means the surface number from 2 to N (any number).

From FIG. 13 disclosure the said Desk Top item which has super big base size so can install plurality of the said rotating USB-Module(s) so can offer a group of people to charge their electric or digital device(s) at the same time such as the train station, bus station, airport, meeting room, hotel lobby . . . etc. Such Desk top item has super big and higher base with plurality USB-modules may call Charging harbor.

From FIG. 14 disclosure the said desk top items with LED means has USB-unit(s) or USB-module or Outlet-unit(s) to allow people charge the other electric or digital device(s) which the said items including radio, time piece, weather station display, fruit blender, food machine, liquid machine, LED lighting, light fixture, projector means, electric fan, heater or any conventional items with LED means build-in and has USB-unit(s) or USB-module(s) build in to allow people charge other electric or digital data device(s) while the stay a period of time near-by the said desk top items.

From FIG. 15 and FIG. 16 and FIG. 17 disclosure the different LEDs means used for LED lighting for above discussed preferred embodiments or other LED Desk lamp or LED lamp for desk top. From all these drawing has details for each LEDs means and its arrangement and details discussion so can save examiner a lot of time to understand the difference and comparison.

From FIG. 18, FIG. 19, FIG. 20, FIG. 21, FIG. 22 disclosure the details of the said USB-Module with at least one of the USB-unit(s) and plurality of receiving means which may has group combination from USB-unit(s), Outlet-unit(s), Internet-unit(s), Adaptor-unit(s), other light means, or other light source with its parts ̂& accessories, or any conventional available receiving means all fall within the current invention for the said USB-Module which has at least more than 2 surface(s) and each surface has its special designs.

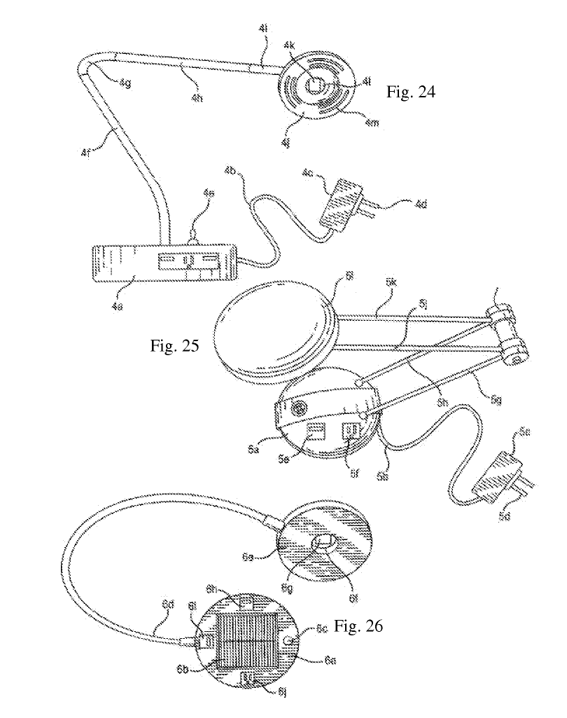

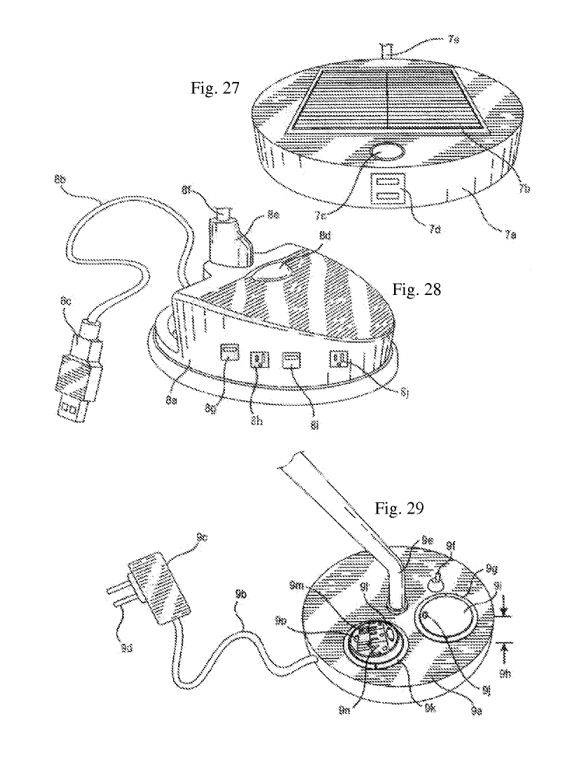

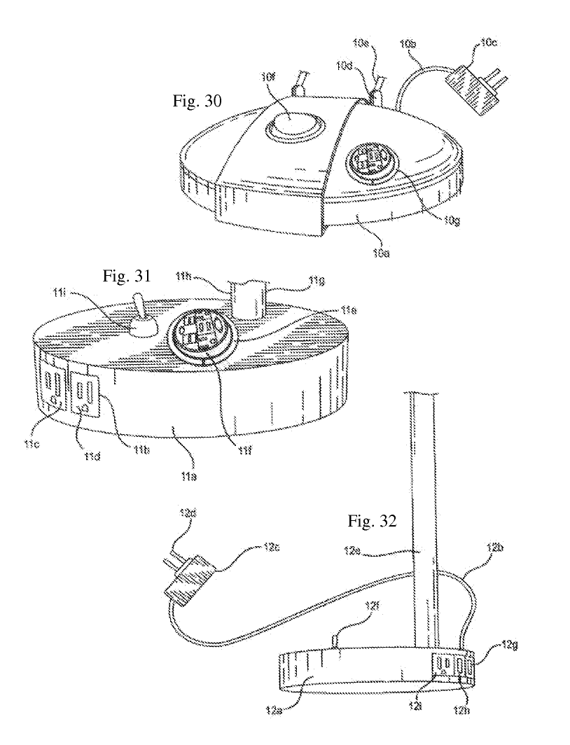

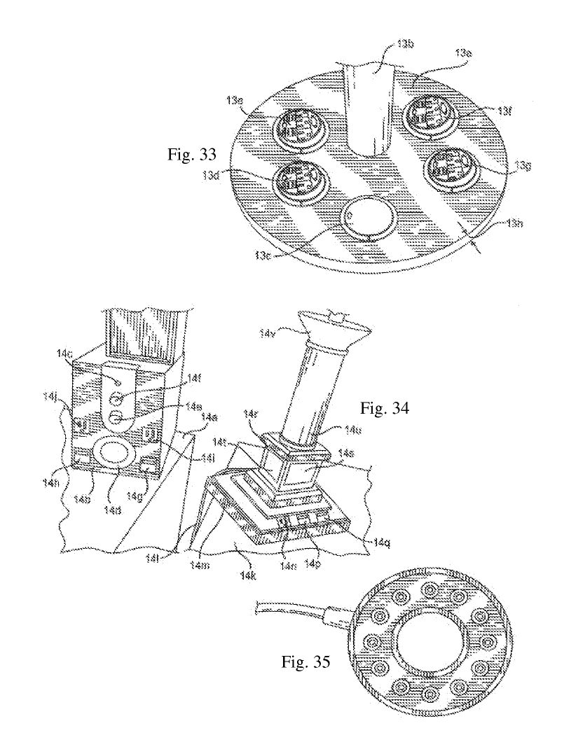

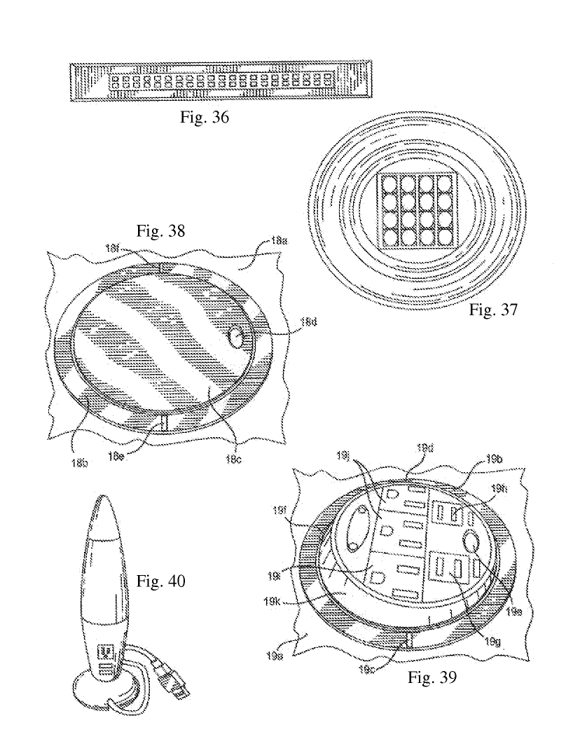

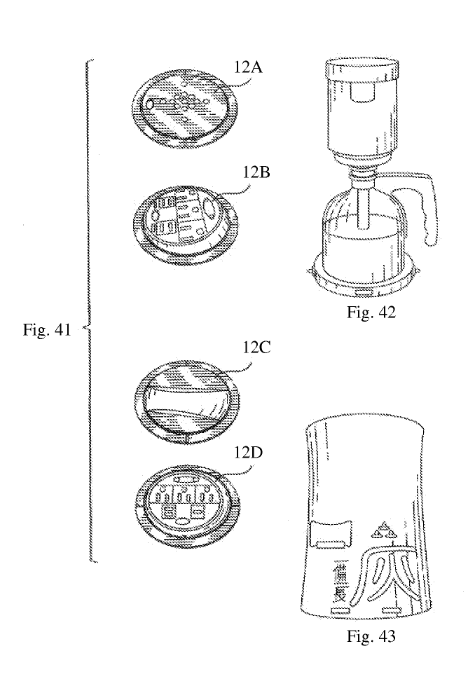

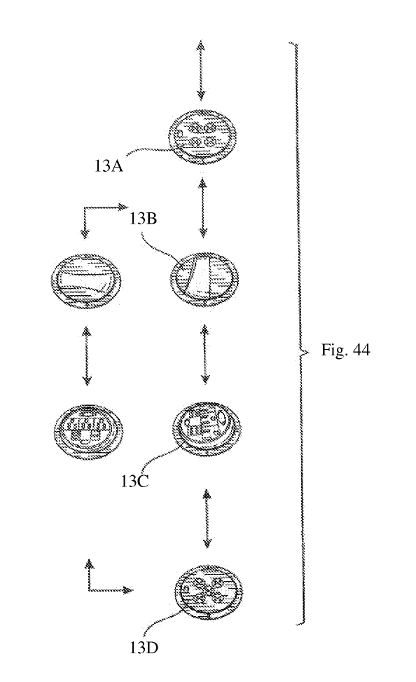

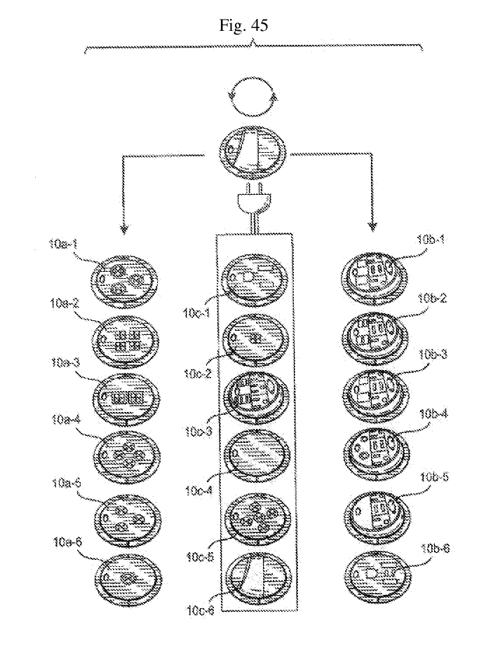

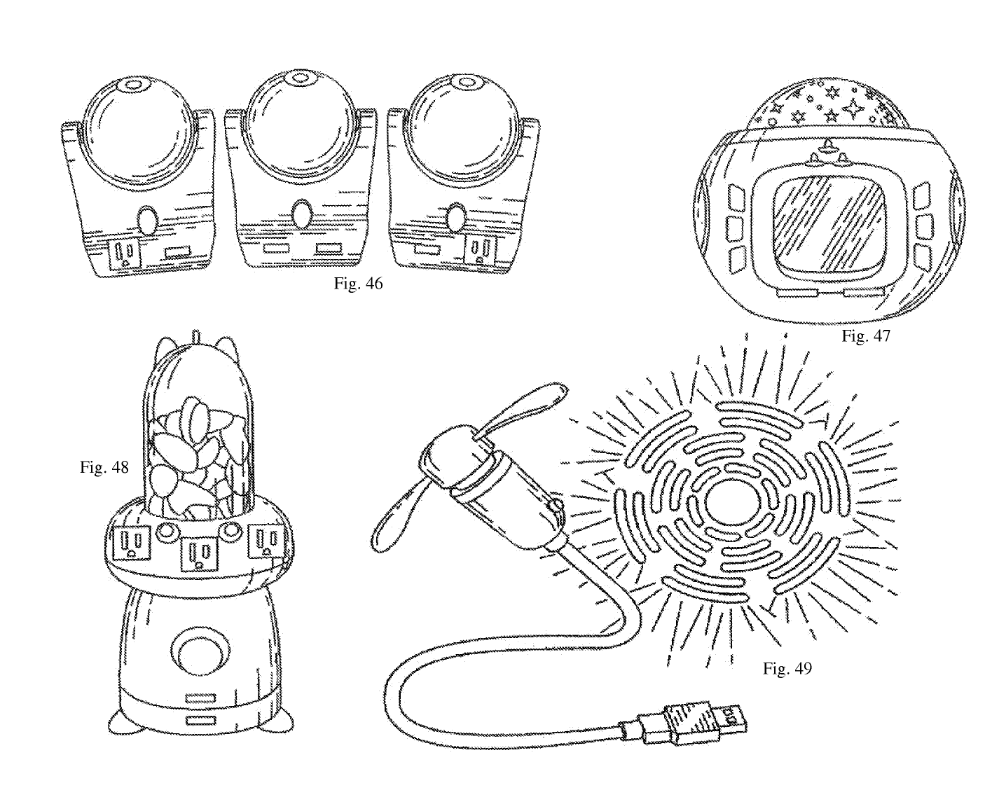

From FIG. 23, FIG. 24, FIG. 25, FIG. 26, FIG. 27, FIG. 28, FIG. 29 disclosure for all kind of the desk top items which offer the function(s), effects(s), performance(s) to people's eye, nose, mouth, ears from the near-by desk top items while people stay a near-by place for a period of time including work, rest, sleep, stand. The details of each Figure show on the Fig's notes for details description.

The Desk Top item has LED means has USB-unit(s) to charge the other electric or digital data device(s) consist of;

At least one of the LED means for the said Desk Top item has LED means which may show the light beams, project image, time image, clock, illumination, music, power source, electric signals, photos, digital signals, certain temperature air flow, moisture, steam, smell, liquid, coffee/tea, food including sound, light, music, smell or any conventional market available devices which people will put near by the body wherever will stay for period of time.

At least one of the said Desk Top items definition is An objects which allow people to easily to reach or touch or operate or management the said device which has LED means and the said LED device are install on or within the some substrate(s) or location or place where near-by people and people will stay for period of time including desk, table, bed, chair, land, grass wherever the place people to work, rest, sit, stand, take nap.

The said Desk Top items has LED means is has certain functions to offer electric signals or functions to people's eye, ear, nose, mouse, body which including illumination, sound, image, brightness, visual effects, smell, water, liquid, food, wind, moisture, airflow or any conventional market available electric devices with build in LED means which many including LED lighting, clock, projector machine, film, digital photo frame, time display, air freshener, electric perfume freshener, moisture spread, electric fan, electric heater, electric steam spreader, electric cooler, electric air conditional or any conventional available items which has build in LED and put on the near by people place to let people can easily reach, touch, operate, manage objects.

The said Desk Top items has LED means has USB-unit(s) which install on or within the certain space of the said Desk Top LED device which may powered by the Direct current power source or Alternative power source incorporate with desire group combination of the electric parts & accessories or components may selected from circuit means, IC means, sensor means, motion sensor, timer means, time delay means, timer, resilient means, conductive means, transformer means, inverter means, adaptor means, wire means, prong means, UL listed adapter means, PIR means, infra-red means, master power control means, AC power outlet-unit(s).

The improvement including:

At least one of the said the USB-unit(s) build in or within the said desk top items has LED means to offer the electric power to charge the other electric or digital data device(s) from the said input Alternative current power source or Direct current power source to certain output power source at desire voltage (Volt) and amperage (Amp or ma) to meet desired charging time required.

The said Desk Top items has LED means has space to proper arrange the USB-unit(s) and other parts.

The said Desk Top items has LED means's USB-unit(s) only offer power source and charging the other electric or digital device(s) which do not has electric data transfer function of the said USB-unit(s).

The desk top items has LED means has USB-unit(s) to charge other electric or digital device(s), the said USB-unit(s) can has plurality of number and each has different output power to charging the different electric or digital data device(s).

The desk top items has LED means has USB-unit(s) to charge other electric or digital device(s), the said AC outlet-unit(s) which has desire number of units which build-in on the said Desk Top items has LED means can supply the desired Alternative current power source.

The desk top items with LED means has USB-unit(s) to charge other electric or digital device(s), the said desk top items has big space to arrange big numbers of the said USB-unit(s) or USB-Module(s) to let plurality peoples can use at same time on public area(s).

The desk top items with LED means has USB-unit(s) to charge other electric or digital device(s), the said USB-Module has at least one of USB-unit(s) and desired number of different receiving means which in group combination from outlet-unit(s), adaptor(s), internet adaptor(s), AC or DC adaptor(s).

The desk top items with LED means has USB-unit or USB-module to charge other electric or digital device(s), the said USB-Module is a rotating unit which has at least more than 2 surface and each surface has its own functions, features, performance, effects with variety and plurality of the different receiving means.

The desk top item with LED means ahs USB-unit or USB-module to charge other electric or digital device(s), the said item is a LED lighting.

The desk top item with LED means ahs USB-unit or USB-module to charge other electric or digital device(s), the other electric or digital data device(s) including available model from convention market which has electric current to drive the power or has digital data within the device(s) including MP3, MP4, smart phone, computer, iphone, ipad, video game, digital visual equipment, communication equipment, consumer electric products.

The desk top item with LED means ahs USB-unit or USB-module to charge other electric or digital device(s), the said charge means the USB-unit(s) or USB-Module(s) supply the electric power source and let the said electric power source and be get into the said other electric or digital device(s) to be powered and operation.

The desk top item with LED means ahs USB-unit or USB-module to charge other electric or digital device(s), the said USB-unit or USB-module(s) can be turn on or turn off under predetermined time for period of time by switch means, sensor means, timer means, photo sensor means, motion means, time delay means, master control power means.

The desk top item with LED means ahs USB-unit or USB-module to charge other electric or digital device(s), the said USB-unit(s) or USB-Module(s) all receiving means may has the removable cover to allow kids to touch or dust, water get into the said receiving means.

The desk top item with LED means ahs USB-unit or USB-module to charge other electric or digital device(s), the said USB-unit(s) or USB-module can be removable from the said desk top items and carry with people to use while people leave the desk top items.

The desk top item with LED means ahs USB-unit or USB-module to charge other electric or digital device(s), the said USB-unit(s) or USB-module(s) can disassembly from the said desk top items and re-assembly into the said desk top items by quickly connector means, adaptor means, assembly means, fix means.

The desk top item with LED means ahs USB-unit or USB-module to charge other electric or digital device(s), the said USB-unit(s) or USB-module(s) has dis-assembly or re-assembly function which the said USB-unit(s) or USB-module(s) has its own safety certification(s) and can sell by its individual USB-unit(s) or USB-module(s) as it is been tested by safety authorities and got its own safety certification.

The desk top item with LED means ahs USB-unit or USB-module to charge other electric or digital device(s), The said USB-unit(s) means an electric charging unit which has USB-female receiving means to receive the USB-male prong to build the electric power delivery from the USB-female receiving means to the other device's USB-male prong. The preferred USB-female receiving means get power from power source and its circuit means to make the desire electric power for current style, voltage, and certain amount of current flow in Amperage (A or ma) so can charge the USB-male means to get power into other electric or digital device(s).

The desk top item with LED means ahs USB-unit or USB-module to charge other electric or digital device(s), The said USB-module(s) means an electric charging module which has at least one USB-female receiving means but also has numbers of the receiving means in group combination select from outlet-female receiving means, USB-female receiving means, adaptor's female receiving means, or any conventional female receiving means to form a one body which has more than one USB-female receiving means to offer same or different electric power though the different female receiving means within the said one body. The said USB-module connect with power source and circuit-means to offer the desire electric power under predetermined current type, voltage, current amperage (A or ma) to charge the other device(s) while the female receiving means connect with the male prong means of each style of the connect-means.

The desk top item with LED means ahs USB-unit or USB-module to charge other electric or digital device(s), the USB-unit(s) the output end to supply the Direct current form to the other electric or digital device(s).

The desk top items with LED means has outlet-unit or outlet-module to supply the electric power to other electric or digital device(s) consist of

At least one of LED means within the desk top items to offer people desired function(s), performance(s), effect(s), features(s), message, status, indicator to people's eye, nose, mouth, ear.

At least one of Outlet-unit or outlet-module build-in the said items to supply the AC current power source to other electric or digital device(s).

The said items may in group combination selected from LED lighting, LED desk lamp, LED table lighting, LED LAVA light, LED project light, LED time piece, LED electric fan, LED air freshner, LED indicator coffee machine, LED indicator sound device, LED visual device.

It is appreciated that all the above discussion, drawing, illustration, co-inventor's prior application and its alternative, same function, equivalent method or improvements still fall within the current invention scope for multiple surface LED light to apply by itself to wall, ceiling, door, closet or incorporate with other main objects, other substrates, other housing means. Any LED light which has more than one surface and can change to other surface(s) will be fall within the current invention.

1. The Power Station has LED & USB means for Desk Top installation consist of;
The power station means has at least one of the said of outlet(s), USB unit(s), LED unit(s) to assemble together to offer multiple power outputs including 110-250 VAC power source, 3.5-8.5 VDC power source and LED illumination at the same time.
The said USB unit(s) directly from inputend to transfer the range of 110-250 VAC house power to become 3.5-8.5 VDC output power for desire electric-current in group combination select from 1.0 A, 2.1 A, 2.4 A or other electric-current to allow the USB-unit(s) can have sufficient charging capability to charge the other electric or digital-data or Audio or Video Device in short time from output ends has 1.0 A, 2.1 A, 2.4 A, 3.1 A, 3.4 A, 4.2 A, 4.5 A, 4.8 A, 5.5 A or any other output power from desired Amperage.
The said Outlet(s) which connect with house 110-250 VAC range input power and supply the 110-250V range as output Power to the make other device(s) perform the desired functions with add electric means which may in group combination including master switch design, MOV design, surge protection design, overload design, over heating design. High voltage design.
The said LED-unit(s) are built-in or fit-in or within the said power station to offer the light illumination under pre-determined function(s), Performance(s), effect(s) while incorporated with IC, sensor means, switch means, remote control means, infra-red means, power fail means, flood-means or other electric or mechanical means.
The improvement including:
The said power station which means the power station may in any geometric shape, size, dimension alone or built-in the said other products and install on the desk top alone or incorporate with the existing desk top products such as desk lamp, more than one functions of extension cord with fix-means, juice maker, micro wave, coffee cup heater, wireless phone base, fax machine, copy machine, office machine, computer monitor, key pads, speaker, communication devices, consumer electric items, fax machine, Printer, scanners, or other device(s) people will use for desk top.
The said power station along or the desk top products means the said power station or desk top product(s) can put on the desk top and it will not be pulled, or be moved or be removed by the weight of the electric cord which it may be less than the 50 feets.
The said power station or the said products in the form of the desk lamp, 3 dimensional products, LED related products, USB charger related products, Outlets related products which need to incorporate with install-means may select from group combination from socketion cup, screw with catch means, phone holder, glue, Double side tap, magnetic means, catcher means, hoop-n-loop means, weight means so can overcome the weight of the said 120 VAC electric code which has very heavy gauge and heavy so have to use the said installation means so can keep the power station or product(s) solid stay on desk top and overcome the such long and heavy electric cord(s).
The Power station or product(s) may optional incorporate with rotating means, spin means, flip-over means to turn the 1^{st} surface to more than one surface(s) to hidden the outlets, USB-Unit(s), LED light unit(s) been seen by viewers and to prevent water, dust, ash to get into the receiving areas.

2. The Power Station has LED & USB means for Desk Top installation as claim 1, The said more than one functions of extension cord with fix-means which can install on the desk top and not be moved, be removed while the said electric cord weight apply to the said more than one function(s) extension-cord device.

3. The Power Station has LED & USB means for Desk Top installation as claim 1, The said power station may incorporate with housing means to apply to existing desk top items such as the desk lamp base, Audio speaker, printer, wireless phone base, book case with geometric shape with attachment means, add-on means, fix means, assembly means hanging means or other market available skill or method, to overlay or underlay to add on the desktop items.

4. The Power Station has LED & USB means for Desk Top installation as claim 1, The said housing means are designed to fit into the existing desk top items which is a Desk Lamp base to overlay or underlay not to occupy more space of limited desk top space but has power station multiple charging functions without operate charging near ground or low-profile area to prevent people to bend body.

5. The Power Station has LED & USB means for Desk Top installation as claim 1, The said the said housing means are design to fit into the existing desk top items which is a desk top computer related products including monitor, key pad, Printer, scanner which can install the power station on its base, or any surface.

6. The Power Station has LED & USB means for Desk Top installation as claim 1, The said the said housing means are design to fit into the existing desk top times which is a communication products including wireless phone base, wireless phone bracket to install the power station on its base, or any surface.

7. The Power Station has LED & USB means for Desk Top installation as claim 1, The said desk top housing means are design to fit into the existing desk top items which is a consumer electric or electronic device such as Time piece, cup heater, TV, Desk Lamp, coffee machine, tea pot, electric tools, hair dryer, lighted mirror, cosmetic mirror with light, music box, fan, heater, air purifier or any other consumer electric products.

8. The Power Station has LED & USB means for Desk Top installation as claim 1, The said desk top housing means are design to fit into the existing desk top items which is a charger sets, extension cord device, multiple functions chargers.

9. The Power Station has LED & USB means for Desk Top installation as claim 1, The said desk top housing means are design to fit into the existing desk top items which the housing means has at least one of material with preferred parts and accessories to form good appearance to let people willing to install on the top of desk surface.

10. The Extension cord has Outlet(s) & USB-Charger(s) for Desk Top installation consist of;
At least one outlet and USB-charger(s) are design on the body which has preferred electric cord has its safety certification and length to connect to the power source by prong-means and can have fix-means, attach-means, weight means, magnetic means, screw and holder means, catcher means, assemble-means to install the said extension cord's body on the desk top or desk's design surface(s) where are people hand can reachable do not need bend the body to work at ground area.
The said extension cord's body can overcome its cord's weight and do not be moved while the extension cord's prong-means connect with power source.
The said extension cord's electric cord has length from 0.5 to 50 feets long and its electric cord has gauge between #12 to #18 basing on safety requirement.
The said USB unit(s) directly from inputend to transfer the range of 110-250 VAC house power to become 3.5-8.5 VDC output power for desire electric-current in group combination select from 1.0 A, 2.1 A, 2.4 A or other electric-current to allow the USB-unit(s) can have sufficient charging capability to charge the other electric or digital-data or Audio or Video Device in short time from output ends has 1.0 A, 2.1 A, 2.4 A, 3.1 A, 3.4 A, 4.2 A, 4.5 A, 4.8 A, 5.5 A or any other output power from desired Amperage.
The said Outlet(s) which connect with house 110-250 VAC range input power and supply the 110-250V range as output Power to the make other device(s) perform the desired functions with add electric means which may in group combination including master switch design, MOV design, surge protection design, overload design, over heating design. High voltage design.

11. The Power station has Outlet(s) and USB charger(s) for desk top installation consist of;
At least one outlet(s) and USB-charger(s) are design on the body which has preferred electric cord has its safety certification and length to connect to the power source by prong-means and can have fix-means, attach-means, weight means, magnetic means, screw and holder means, catcher means, assemble-means to install the said Power station's body on the desk top or desk's design surface(s) where are people hand can reachable do not need bend the body to work at ground area.
The said Power Station's body can overcome its cord's weight and do not be moved while the extension cord's prong-means connect with power source.
The said Power Station's electric cord has length from 0.5 to 50 feets long and its electric cord has gauge between #12 to #18 basing on safety requirement.
The said USB unit(s) directly from inputend to transfer the range of 110-250 VAC house power to become 3.5-8.5 VDC output power for desire electric-current in group combination select from 1.0 A, 2.1 A, 2.4 A or other electric-current to allow the USB-unit(s) can have sufficient charging capability to charge the other electric or digital-data or Audio or Video Device in short time from output ends has 1.0 A, 2.1 A, 2.4 A, 3.1 A, 3.4 A, 4.2 A, 4.5 A, 4.8 A, 5.5 A or any other output power from desired Amperage.
The said Outlet(s) which connect with house 110-250 VAC range input power and supply the 110-250V range as output Power to the make other device(s) perform the desired functions with add electric means which may in group combination including master switch design, MOV design, surge protection design, overload design, over heating design. High voltage design.

12. The desk-top product has a assemble-kits which has built-in USB charger(s) and Outlet(s) consist of;
At least one outlet(s) and USB-charger(s) are design on to fit within the assemble-kits which has preferred electric cord has its safety certification and length to connect to the power source by prong-means and can have fix-means, attach-means, weight means, magnetic means, screw and holder means, catcher means, assemble-means to install the said assemble-kits to the product's body for the desk top or desk's design surface(s) to use to let people hand can reachable do not need bend the body to work at ground area.
The said product's body can overcome assemble-kit's cord weight and do not be moved while the extension cord's prong-means connect with power source.
The said assemble-kit's electric cord has length from 0.5 to 50 feets long and its electric cord has gauge between #12 to #18 basing on safety requirement.
The said USB unit(s) directly from inputend to transfer the range of 110-250 VAC house power to become 3.5-8.5 VDC output power for desire electric-current in group combination select from 1.0 A, 2.1 A, 2.4 A or other electric-current to allow the USB-unit(s) can have sufficient charging capability to charge the other electric or digital-data or Audio or Video Device in short time from output ends has 1.0 A, 2.1 A, 2.4 A, 3.1 A, 3.4 A, 4.2 A, 4.5 A, 4.8 A, 5.5 A or any other output power from desired Amperage.
The said Outlet(s) which connect with house 110-250 VAC range input power and supply the 110-250V range as output Power to the make other device(s) perform the desired functions with add electric means which may in group combination including master switch design, MOV design, surge protection design, overload design, over heating design. High voltage design.
The assemble-kits in geometric design and can fit-within, add-on, attach-on, hook-on, glue-on or other market available skill to incorporate with the said products.
The said products are one of house furniture, electric consumer products, computer related products, communication related products, digital-data related products, audio products, video products, internet related products.
